(19) United States
(12) Patent Application Publication
(10) Pub. No.: US 2008/0061970 A1
(43) Pub. Date: Mar. 13, 2008

(54) Monitoring Device and Program Thereof

(75) Inventors: Makoto Imai, Nara (JP); Naofumi Nakatani, Osaka (JP); Hiroyuki Ogino, Nara (JP); Hirofumi Inui, Osaka (JP); Takaaki Okude, Nara (JP); Makoto Shibuya, Nara (JP); Ryuta Kondou, Nara (JP); Miyuki Kawai, Nara (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Kadoma-shi, Osaka (JP)

(21) Appl. No.: 11/572,921

(22) PCT Filed: Aug. 4, 2005
(86) PCT No.: PCT/JP05/14334

§ 371 Date: Jan. 30, 2007

(30) Foreign Application Priority Data
Aug. 5, 2004 (JP) 2004-229211
Aug. 5, 2004 (JP) 2004-229212
Apr. 12, 2005 (JP) 2005-114129
Jul. 25, 2005 (JP) 2005-213669

(51) Int. Cl. G08B 13/10

(52) U.S. Cl. 340/545.1; 340/541

(57) ABSTRACT

An object of the invention is to provide a monitoring device that can be mounted in a window or a door in which because the window is often opened or closed by the user, if the monitoring device is installed on the window, the user must perform an operation of releasing the monitoring device, every time of opening or closing the window.

An intrusion detecting terminal unit (13) having an opening/closing sensor is disposed on the window or door, a mat (16) containing a piezoelectric sensor (15) is disposed near under the window, and each of the intrusion detecting terminal unit (13) with the opening/closing sensor and the intrusion detecting terminal unit (15a) with the piezoelectric sensor comprises data communication means for transmitting or receiving data. In case of the intrusion, the intrusion detecting terminal unit (15a) under the window detects the intruder, and then if the intruder tries to open the window, the intruder is judged. However, when the user opens the window, the intrusion detecting terminal unit (15a) does not make the detection, and the intrusion detecting terminal unit (13) alone detects the opening of the window, whereby the user does not need to release the monitoring device every time of opening the window.

### TECHNICAL FIELD

The present invention relates to a monitoring device for crime prevention, a method of disposition the device, and a program thereof.

### BACKGROUND ART

The conventional monitoring device of this type is an intruder sensor for crime prevention in which if a vibration sensor mounted on a window glass detects the vibration when the intruder touches a window, or when the intruder opens the window, it sounds a burglar buzzer to threaten the intruder or inform the resident that the intrusion is detected (e.g., refer to patent document 1).

FIG. 30 shows the conventional monitoring device as described in patent document 1. As shown in FIG. 30, an intruder detector for crime prevention has a simple crime preventing intruder detector 1 using a vibration sensor that is mounted on a window glass 2 to detect the intruder due to the vibration when the intruder touches a window or the vibration when the intruder opens the window, ring a burglar buzzer contained in the crime preventing intruder detector to threaten the intruder, and inform the resident that the intruder is detected.

Also, the conventional monitoring device of this type is an intrusion guard fence as well known in which a cable-like vibration detection sensor is disposed on a fence or the like, and when the fence is vibrated by intrusion, an external force such as vibration or impact is applied to the cable-like vibration detection sensor disposed on the fence, thereby detecting the intrusion (e.g., refer to patent document 2).

FIG. 31 shows the conventional safeguard fence as described in patent document 2. As shown in FIG. 31, a sensing cable 222 for the intrusion sensor to detect the intrusion is wired to an intrusion safeguard fence 231 disposed around the circumference of a certain district. And one end of the sensing cable 222 is led to a control box 223 near the fence 231 through a connection pipe 241 buried in the ground, and the other end is connected to a terminator 224 provided at a strut 232. And when the intruder climbs up the fence 231, or applies an impact, the vibration or impact applied to the fence 231 is sensed through the cable 222.

Also, the conventional monitoring device of this type is an intrusion alarm device that threatens the intruder or animal by light or sound if a cable-like vibration sensor attached on the fence detects the vibration of the fence (e.g., refer to patent document 3).

FIG. 32 shows the conventional monitoring device as described in patent document 3. As shown in FIG. 32, an intrusion alarm device detects the vibration through a vibration sensing cable 5 for detecting the vibration of a fence or the like, and converts its vibration energy into electrical energy to generate an electrical signal. And the electrical signal from the vibration sensing cable 5 is amplified by an amplifier 6, and a discrimination control circuit discriminates the presence or absence of intrusion from the electrical signal amplified by the amplifier 6, in which if it is judged that there is any intrusion, an alarm is sounded from a speaker 2 or the intruder is threatened with a strobe 3.

Patent document 1: JP-A-2002-190069

Patent document 2: JP-A-1-6478

Patent document 3: JP-A-11-296755

### DISCLOSURE OF INVENTION

### Problems to be solved by Invention

However, with the above conventional constitution, if the intruder detector for crime prevention was disposed on the window, the user was required to turn off the power of the intruder detector for crime prevention every time the user opened the window. Also, there was a problem that the user might be threatened by the alarm if he or she forgot to turn off the power. Also, there was a problem that when the window was vibrated by strong wind, or struck by an object, a false report was made misjudging the intruder.

Also, with the conventional constitution, since the vibration was detected by one sensing cable of the intrusion sensor, there was a problem that it was difficult to determine the intrusion place, and the intrusion was misjudged when the vibration was detected due to the influence of a natural phenomenon such as rain or wind.

Also, with the conventional constitution, the intrusion alarm device was disposed in the veranda, and the user was required to turn off the power of the intrusion alarm device every time of using the veranda. Also, there was a problem that the user might be threatened by alarm or light if he or she forgot to turn off the power.

This invention has been achieved to solve the above-mentioned problems associated with the prior art, and it is an object of the invention to provide a monitoring device in which when the monitoring device is disposed in the window, the user does not need to manipulate the monitoring device to threaten the intruder but not to threaten the user. Further, it is another object of the invention to provide a monitoring device for locking or unlocking the porch door while the user is unconscious, or starting or releasing the monitoring operation of a terminal unit for detecting the intruder disposed in the premises.

Also, the invention has been achieved to solve the above-mentioned problems with the prior art, and it is another object of the invention to provide a monitoring device that is disposed on the fence or the like, in which an intrusion place can be specified, and further when the vibration is detected by an intrusion sensor, it is determined whether the detection is made due to the influence of rain or wind or the intrusion, without making the false detection.

Also, the invention has been achieved to solve the above-mentioned problems with the prior art, and it is a further object of the invention to provide a monitoring device that device is disposed in the veranda or the like, in which when the user gets out to the veranda, the user does not manipulate the monitoring device to release the monitoring operation or notify a state of monitoring operation, whereby the user does not falsely raise the alarm.

### Means for Solving the Problems

In order to accomplish the above objects, a monitoring device of the invention comprises an opening/closing sensor terminal unit for detecting the opening/closing of a window or a door, which is disposed in the window or the door, a piezoelectric sensor terminal unit for detecting the presence or absence of a person or animal from a change in the load due to a step, which is disposed on the outdoor side under the window or near the door, and data communication means for transmitting or receiving data, which is provided in each of the opening/closing sensor terminal unit and the piezoelectric sensor terminal unit, wherein the piezoelectric sensor terminal unit, upon detecting the presence of the person, transmits the person's presence information to the opening/closing sensor terminal unit, and then upon detecting the opening of the window or door, the opening/closing sensor terminal unit raises an alarm for threat, but does not raise the alarm when the user opens the window from inside the room, because the piezoelectric sensor terminal unit does not detect the presence of the person, whereby the user does not need to turn off the terminal unit to raise the alarm to threaten the intruder but not to raise the alarm to the user.

Also, in order to accomplish the above objects, a monitoring device of the invention comprises a plurality of piezoelectric sensor terminal units having a cable-like piezoelectric sensor having compliance, and determination means for determining the pressure or vibration of an object based on an output signal from said piezoelectric sensor, and a fence consisting of a plurality of fence members provided around a house and connected, characterized in that the piezoelectric sensor terminal unit is mounted on each single fence member. Since the piezoelectric sensor terminal unit is mounted on each single fence member, the state of each fence member is detected distinctively, whereby it is possible to specify from which place the intrusion occurs, depending on which sensor outputs a detection signal over the entire fence.

Also, in order to accomplish the above objects, a monitoring device of the invention comprises a first intrusion detecting terminal unit installed on a handrail of a veranda in the intrusion into a house from the veranda, and a second intrusion detecting terminal unit installed in a window or a door into or out of the veranda, in which the first intrusion detecting terminal unit and the second intrusion detecting terminal unit monitors a steady or unsteady state, and have data communication means capable of communicating a signal concerning the steady or unsteady signal with each other, whereby the first intrusion detecting terminal unit can start or release the monitoring in accordance with the steady or unsteady state of the second intrusion detecting terminal unit. For example, when the user gets out to the veranda, the second intrusion detecting terminal unit transmits an unsteady signal, and the first intrusion detecting terminal unit releases the monitoring, whereas when the user gets into the house from the veranda, the second intrusion detecting terminal unit transmits a steady signal, and the first intrusion detecting terminal unit starts the monitoring.

### EFFECT OF THE INVENTION

With the monitoring device and its program according to the invention, when the user tries to open the window in which the intrusion detecting terminal unit is installed, it is possible to raise the alarm to threaten the intruder without the necessity of the user turning off the power every time, thereby improving the ease-of-use for the user.

Also, with the monitoring device of the invention, since the cable-like piezoelectric sensor for detecting the intrusion is disposed on each single fence, the intrusion place can be specified. Therefore, it is possible to threaten the intruder at an appropriate place by specifying the intrusion place. Also, the information of the specified intrusion place can be utilized for later monitoring to strengthen the monitoring for the place where the intrusion occurs. Also, since whether the sensor detection is due to the influence of rain or wind or the intrusion can be determined from the output signals from the plurality of cable-like piezoelectric sensors, there is no false detection, whereby the user can employ the monitoring device with a sense of security.

Also, with the monitoring device and its program according to the invention, in the case where the monitoring device is installed on the intrusion path into the house, for example, in the veranda, the monitoring operation can be started or released in accordance with the behavior of the user, whereby the user does not need to turn off the power of the monitoring device every time. Also, there is no false detection that the monitoring device detects the user, thereby improving the ease-of-use for the user.

### BRIEF DESCRIPTION OF THE DRAWINGS

FIG. 1 is a constitutional view of a domicile having installed a monitoring device according to an embodiment 1 of the present invention.

FIG. 2A is an internal block diagram of an intrusion detecting terminal unit having a piezoelectric sensor according to the embodiment 1 of the invention, and FIG. 2B is a constitutional view of the piezoelectric sensor.

FIG. 3 is a cross-sectional view of the piezoelectric sensor according to the embodiment 1 of the invention, taken along the line A-A.

FIG. 4 is an internal block diagram of the intrusion detecting terminal unit having an opening/closing sensor according to the embodiment 1 of the invention.

FIG. 5 is a characteristic chart showing the output signal of a filter part and the output signal of a comparator part, varying over time, when the person is detected by the intrusion detecting terminal unit with the piezoelectric sensor according to the embodiment 1 of the invention.

FIG. 6 is a constitutional view of a domicile having installed a monitoring device according to a second embodiment 2 of the invention.

FIG. 7 is an explanatory view for explaining a constitution of attaching an intrusion detecting sensor for an intrusion detecting terminal unit according to the embodiment 2 of the invention.

FIG. 8 is a constitutional view of a porch having installed a monitoring device according to an embodiment 3 of the invention.

FIG. 9 is an internal block diagram of a lock device according to the embodiment 3 of the invention.

FIG. 10 is an internal block diagram of a remote control terminal unit according to the embodiment 3 of the invention.

FIG. 11 is a system block diagram of a monitoring device according to an embodiment 4 of the invention.

FIG. 12 is an internal block diagram of a central processing unit according to the embodiment 4 of the invention.

FIGS. 13A and 13B are internal block diagram of a piezoelectric sensor terminal unit according to an embodiment 5 of the invention.

FIG. 14 is a cross-sectional view of a piezoelectric sensor according to the embodiment 5 of the invention.

FIGS. 15A to 15C are views showing a fence structure according to the embodiment 5 of the invention.

FIGS. 16A and 16B are views showing a gate door structure according to the embodiment 5 of the invention.

FIG. 17 is a view showing another fence structure according to the embodiment 5 of the invention.

FIG. 18 is an internal block diagram of a piezoelectric sensor terminal unit according to an embodiment 6 of the invention.

FIG. 19 is a view showing a fence structure according to the embodiment 6 of the invention.

FIG. 20 is a constitutional view of a central processing unit and a piezoelectric sensor terminal unit according to the embodiment 6 of the invention.

FIGS. 21A and 21B are internal block diagrams of the piezoelectric sensor terminal unit according to the embodiment 6 of the invention.

FIG. 22 is a system block diagram of a monitoring device according to an embodiment 7 of the invention.

FIG. 23 is an internal block diagram of a central processing unit according to the embodiment 7 of the invention.

FIG. 24A is an internal block diagram of a terminal unit according to the embodiment 7 of the invention and FIG. 24B is a constitutional view of a piezoelectric sensor according to the embodiment 7 of the invention.

FIG. 25 is a cross-sectional view of the piezoelectric sensor according to the embodiment 7 of the invention.

FIG. 26 is an internal block diagram of the terminal unit according to the embodiment 7 of the invention.

FIG. 27 is a flowchart showing an operation procedure according to the embodiment 7 of the invention.

FIG. 28 is a connection configuration diagram of the monitoring device with off premises according to the embodiment 7 of the invention.

FIG. 29 is an internal block diagram of a terminal unit according to an embodiment 8 of the invention.

FIG. 30 is a block diagram of the conventional monitoring device.

FIG. 31 is a block diagram of the conventional monitoring device.

FIG. 32 is a block diagram of the conventional monitoring device.

### DESCRIPTION OF REFERENCE NUMERALS AND SIGNS

13 intrusion detecting terminal unit having opening/closing sensor
14a, 14b piezoelectric sensors
15a intrusion detecting terminal unit having piezoelectric sensor
15b intrusion detecting terminal unit having piezoelectric sensor
21 intrusion detecting part
22 center electrode
23 ground electrode
24 sensor side resistor
25 circuit side resistor
26 signal deriving resistor
27 filter part
28 abnormality determination part
29 data communication means
30 report means
31 battery
32 terminal control part
33 piezoelectric layer
34 comparator part
35 elastic body
36 buffer part
37 covering layer
250 intrusion detection part
251 center electrode
252 ground electrode
253 censor side resistor
254 circuit side electrode
255 signal deriving resistor
256 filter part
257 abnormality determination part
258 report means
259 battery
260 terminal control part
261 determination means
262 piezoelectric layer
263 piezoelectric sensor
264 buffer part
265 elastic body
266 fence
267 covering layer
268 intrusion determination means
269 block ringwall
270 piezoelectric sensor terminal unit
280 vibration propagation member
290 central processing unit
291, 295 data communication means
292 report part
293 display part
294 control part
295 gate door
296 fence
320 central processing unit
321 first intrusion detecting terminal unit (veranda sensor terminal unit)
322 second intrusion detecting terminal unit (opening/closing sensor terminal unit)
323 third intrusion detecting terminal unit (surveillance camera)
324 remote control
330, 348, 360, 380 data communication means
331 monitoring operation delay time setting means
332 display means
333 recording means
334 control part
340, 361 intrusion detection parts
341 center electrode
342 ground electrode
343 sensor side resistor
344 circuit side resistor
345 signal deriving resistor
346 filter part
347 abnormality determination part
349, 363 report means
350 battery
351, 362, 372 terminal control parts
352 piezoelectric layer
353 piezoelectric sensor
354 buffer part
355 elastic body
356 veranda
357 covering layer
370 line connection means
371 off premises line network
372 center server apparatus
381 operation input means

### BEST MODE FOR CARRYING OUT THE INVENTION

A first invention is a monitoring device having a plurality of intrusion detecting terminal units comprising an intruder detection sensor for detecting an intruder, data communication means for making the data communication of detection information of the intruder detection sensor with each other, and report means for making a report based on data communicated by the intruder detection sensor and the data communication means, wherein at least one of the intrusion detection sensors is an opening/closing sensor, disposed at an opening/closing part such as a window or a door of the house, for detecting the opening/closing of the opening/closing part, and at least the other one of the intrusion detection sensors is a piezoelectric sensor, disposed on a member installed near under the opening/closing part to step into when the intruder intrudes into the house from the outdoor side of the opening/closing part, for detecting the step of the intruder near under the opening/closing part, in which if the piezoelectric sensor detects the intrusion, the report means makes a first report, and the data communication means transmits data to the intruder detecting terminal unit with the opening/closing sensor, and if the intrusion detecting terminal unit with the opening/closing sensor detects the opening of the window or door, the report means makes a second report.

Hence, before the intruder opens the window or door, the intrusion detecting terminal unit with the piezoelectric sensor provided on the member under the window firstly makes the detection and informs the person at home by giving a report for drawing the attention to threaten the intruder, whereby it is possible to disperse the intruder without breaking the window or door. Thereafter, when the opening of the window or door is detected, another report is given for threat, so that the intrusion is reliably detected without giving a false report, whereby the reliability of crime prevention is improved.

A second invention is the monitoring device according to the first invention, wherein at least one of the intrusion detection sensors is an opening/closing sensor, disposed at an opening/closing part such as a window or a door of the house, for detecting the opening/closing of the opening/closing part, and at least the other one of the intrusion detection sensors is a piezoelectric sensor, disposed on a handrail of the veranda on the outdoor side of the opening/closing part, for detecting that the intruder climbs over the handrail of the veranda, in which if the piezoelectric sensor detects the intrusion, the report means makes a first report, and the data communication means transmits data to the intruder detecting terminal unit with the opening/closing sensor, and if the intrusion detecting terminal unit with the opening/closing sensor detects the opening of the window or door, the report means makes a second report.

Hence, if the intruder tries to climb over the veranda, the intrusion detecting terminal unit with the piezoelectric sensor makes the detection and informs the person at home by giving a report for drawing the attention, or threatens the intruder, whereby it is possible to disperse the intruder without breaking the window or door. Thereafter, when the opening of the window or door is detected, another report is given for threat, so that the intrusion is reliably detected without giving a false report, whereby the reliability of crime prevention is improved.

A third invention is the monitoring device according to the first or second invention, wherein if the opening of the opening/closing part is detected by the opening/closing sensor before the intrusion is detected by the cable-like piezoelectric sensor, the report means gives no report.

Hence, when the user opens the window or door from the indoor side, no report is given without judging the intrusion, whereby the precision of intrusion detection is improved and the ease-of-use is improved for the user, who does not need to perform an operation of turning off the power of the terminal unit.

A fourth invention is the monitoring device according to any one of the first to third inventions, wherein at least one of the intrusion detection sensors is a piezoelectric sensor, disposed on a handrail of the veranda on the outdoor side of the opening/closing part, for detecting that the intruder climbs over the handrail of the veranda, and at least the other one of the intrusion detection sensors is a piezoelectric sensor, disposed on a member installed near under the opening/closing part to step into when the intruder intrudes into the house from the outdoor side of the opening/closing part, for detecting the step of the intruder near under the opening/closing part, in which if the piezoelectric sensor disposed on the handrail of the veranda detects the intrusion, the report means makes a first report, and the data communication means transmits data to another intruder detecting terminal unit, and if the piezoelectric sensor disposed on the member installed near under the opening/closing part detects the intrusion, the report means makes a second report.

Hence, if the intruder tries to climb over the veranda, the intrusion detecting terminal unit with the piezoelectric sensor makes the detection and informs the person at home by giving a report for drawing the attention, or threatens the intruder, whereby it is possible to disperse the intruder without breaking the window or door. Thereafter, when the intruder is detected by the intrusion detecting terminal unit provided under the window, another report for threat is given, so that the intrusion is reliably detected without giving a false report, whereby the reliability of crime prevention is improved.

A fifth invention is the monitoring device according to the fourth invention, wherein if the intrusion is detected by the piezoelectric sensor disposed on the member installed near under the opening/closing part before the intrusion is detected by the piezoelectric sensor disposed on the handrail of the veranda, the report means gives no report.

Hence, when the user gets out to the veranda from the indoor side to hang out the bedding or washing in the veranda, no report is given without judging the intrusion, whereby the precision of intrusion detection is improved and the ease-of-use is improved for the user, who does not need to perform an operation of turning off the power of the terminal unit.

A sixth invention is a program for enabling a computer to perform at least a part of the functions of the monitoring device according to any one of the first to fifth inventions. Because of the program, at least a part of the monitoring device of the invention can be easily realized in cooperation with the hardware resources such as an electrical information apparatus, a computer and a server. Also, the program is recorded on a recording medium, or distributed via the communication line, whereby the distribution or update of the program, as well as its installation operation, can be simply performed.

A seventh invention is a monitoring device comprising a plurality of piezoelectric sensor terminal units having a cable-like piezoelectric sensor having compliance, and determination means for detecting the pressure or vibration of an object based on an output signal from the piezoelectric sensor, characterized in that a fence consisting of a plurality of fence members provided around the dwelling are connected, with a piezoelectric sensor terminal unit being mounted on each of the fence members of the fence. Hence, the detection information can be obtained at every position of the fence to specify the intrusion location. Also, it is possible to make a threat such as an alarm at the place where intrusion occurs.

An eighth invention is a monitoring device comprising a plurality of piezoelectric sensor terminal units having a cable-like piezoelectric sensor having compliance, and determination means for detecting the pressure or vibration of an object based on an output signal from the piezoelectric sensor, characterized in that a fence consisting of a plurality of fence members provided around the dwelling are connected, in which the plurality of piezoelectric sensor terminal units are mounted at established intervals by connecting the connection parts of the fence via a vibration propagation member. Hence, the adjacent fences are connected via the vibration propagation member, and the piezoelectric sensor terminal units are disposed at established intervals on the single fence, whereby the number of piezoelectric sensor terminal units to be disposed can be reduced. Therefore, the disposition cost is lower.

A ninth invention is the monitoring device according to the eighth invention, comprising a case for covering the determination means, in which the cover also serves as the vibration propagation member. Hence, since the vibration propagation member is employed for the case of the piezoelectric sensor terminal unit, the piezoelectric sensor terminal unit itself also serves as the vibration propagation member, whereby the fences with the piezoelectric sensor terminal unit mounted are more easily connected.

A tenth invention is a monitoring device comprising one or more piezoelectric sensor terminal units having a plurality of cable-like piezoelectric sensors having compliance, and one determination means for detecting the pressure or vibration of an object based on the output signals from the plurality of piezoelectric sensors, characterized in that a fence consisting of a plurality of fence members provided around the dwelling are connected, in which the piezoelectric sensor is mounted for each single fence member or at an interval. Hence, since one determination means for detecting the pressure or vibration can detect the pressure or vibration at a position where the piezoelectric sensor is disposed, whereby the cost is lower.

An eleventh invention is the monitoring device according to any one of the seventh to tenth inventions, further comprising intrusion determination means, in which if the output signals at similar levels are detected from the plurality of piezoelectric sensors, the detection due to the natural phenomenon such as rain, wind or earthquake is determined and distinguished from the detection due to the intrusion, whereby the false detection is prevented.

A twelfth invention is the monitoring device according to any one of the seventh to eleventh inventions, further comprising a central processing unit that can communicate with the piezoelectric sensor terminal unit, in which the plurality of piezoelectric sensor terminal units can be controlled from the central processing unit within the premises, making it easy to work the piezoelectric sensor terminal units.

A thirteenth invention is a monitoring device, comprising the intrusion detecting terminal units provided on an intrusion path to the dwelling, including a first intrusion detecting terminal unit for detecting the intrusion on the intrusion path earlier and a second intrusion detecting terminal unit provided to detect the intrusion later than the first intrusion detecting terminal unit, in which the first intrusion detecting terminal unit and the second intrusion detecting terminal unit monitor a steady or unsteady state, and have data communication means that can communicate a signal concerning the state with each other, whereby the monitoring is started or released in accordance with each state.

And the first intrusion detecting terminal unit and the second intrusion detecting terminal unit are provided on the intrusion path to the dwelling to monitor in accordance with each state, whereby the intruder intruding from the outside can be detected reliably, and the user within the premises is prevented from being falsely detected as the intruder in a range where the intrusion detecting terminal units monitor.

First of all, on an intrusion path of entering the veranda of the dwelling and intruding into the dwelling from the window, for example, the first intrusion detecting terminal unit is installed on the handrail of veranda and the second intrusion detecting terminal unit is installed on the window or door into or out of the veranda, whereby the intruder from the veranda can be reliably detected, and the user has a greater sense of security. Further, the first intrusion detecting terminal unit and the second intrusion detecting terminal unit monitor the steady or unsteady state, and each comprise the data communication means that can communicate the signal concerning the steady or unsteady state with each other, whereby the first intrusion detecting terminal unit can start or release the monitoring in accordance with the steady or unsteady state of the second intrusion detecting terminal unit. Therefore, it is possible to distinguish between the case where the intruder intrudes into the dwelling from the veranda and the case where the user gets out of the dwelling to the veranda, whereby excluding the case where the intruder is not to be monitored, namely, the user gets out to the veranda, the monitoring can be performed.

A fourteenth invention is the monitoring device according to the thirteenth invention, where if the first intrusion detecting terminal unit receives an unsteady signal of the second intrusion detecting terminal unit prior to detecting the unsteady state on its own, the monitoring is released.

In the case where there is the possibility that the first intrusion detecting terminal unit falsely detects the user as the intruder, first of all, the second intrusion detecting terminal unit is placed in the unsteady state, whereby if the second intrusion detecting terminal unit is placed in the unsteady state ahead of the first intrusion detecting terminal unit, the monitoring of the first intrusion detecting terminal unit is released. For example, when the user tries to get out to the veranda and opens the window or door, an unsteady signal from the second intrusion detecting terminal unit is sent to the first intrusion detecting terminal unit, and the first intrusion detecting terminal unit releases the monitoring. Therefore, judging the case where there is no need of making the monitoring, namely, the user is out in the veranda, the monitoring is disabled, whereby the user does not need to release the monitoring for the first intrusion detecting terminal unit or turn off the power.

A fifteenth invention is the monitoring device according to the thirteenth or fourteenth invention, where the first intrusion detecting terminal unit starts the monitoring, if receiving a steady signal from the second intrusion detecting terminal unit.

For example, when the user enters the dwelling from the veranda and closes the window or door, a steady signal from the second intrusion detecting terminal unit is sent to the first intrusion detecting terminal unit, and the first intrusion detecting terminal unit starts the monitoring. Therefore, if the first intrusion detecting terminal unit and the second intrusion detecting terminal unit are in the steady state, the monitoring can be started, judging that it is required to make the monitoring, namely, the user is not in the veranda. Hence, when the user enters the dwelling from the veranda, it is not required to start the monitoring for the first intrusion detecting terminal unit.

A sixteenth invention is the monitoring device according to any one of the thirteenth to fifteenth inventions, wherein the start of monitoring of the intrusion detecting terminal unit can be delayed. Therefore, if a steady signal is sent from the second intrusion detecting terminal unit to the first intrusion detecting terminal unit, the first intrusion detecting terminal unit has a delay time to start the monitoring. Therefore, when the user works in the veranda, the first intrusion detecting terminal unit does not start to monitor to detect the user, even if the user works with the window or door to the veranda closed.

A seventeenth invention is the monitoring device according to any one of the thirteenth to sixteenth inventions, wherein the intrusion detecting terminal unit is provided with report means. Therefore, when the intrusion is detected, an alarm can be sounded. Also, a monitoring state of the intrusion detecting terminal unit can be reported, whereby the user can confirm whether the monitoring is started or released visually or aurally.

An eighteenth invention is the monitoring device according to any one of the thirteenth to seventeenth inventions, further comprising a central processing unit communicable with a plurality of intrusion detecting terminal units, the central processing unit comprising display means for displaying a monitor or detection status of the intrusion detecting terminal unit, and recording means for recording the monitor or detection status of the intrusion detecting terminal unit, in which the central processing unit can control the plurality of intrusion detecting terminal units by starting or releasing the monitoring of the plurality of intrusion detecting terminal units, whereby it is not required that the user gets out to the place where the intrusion detecting terminal units are installed to make the operation.

A nineteenth invention is the monitoring device according to any one of the thirteenth to eighteenth inventions, further comprising a remote controller communicable with a plurality of intrusion detecting terminal units to release the monitoring of the specific intrusion detecting terminal unit. If the user carries the remote controller, the monitoring of the intrusion detecting terminal units can be released at any time.

A twentieth invention is the monitoring device according to the nineteenth invention, wherein a monitoring release signal originated from the remote controller originates to the intrusion detecting terminal unit is kept for a predetermined time. Thereby, it is possible to prevent the user from forgetting to turn off the power.

A twenty first invention is the monitoring device according to the nineteenth or twentieth invention, wherein the intrusion detecting terminal unit starts the monitoring in a predetermined time since receiving a monitoring release signal from the remote controller. Therefore, even if the user left the remote controller near the intrusion detecting terminal unit, the intrusion detecting terminal unit can start the monitoring, whereby the user has a greater sense of security.

A twenty second invention is the monitoring device according to any one of the nineteenth to twenty first invention, wherein the intrusion detecting terminal unit releases the monitoring while receiving a release signal from the remote controller, but performs the monitoring if receiving no release signal. Therefore, if the user goes near the intrusion detecting terminal unit, carrying the remote controller, the intrusion detecting terminal unit releases the monitoring, whereby it is not required that the user releases the monitoring of the intrusion detecting terminal unit every time. Also, if the user keeps away from the intrusion detecting terminal unit, the monitoring is started, thereby improving the ease-of-use for the user.

A twenty third invention is the monitoring device according to any one of the thirteenth to twenty second inventions, wherein the first intrusion detecting terminal unit is installed more outward on the intrusion path than the second intrusion detecting terminal unit, as seen from the inside of the dwelling in the monitoring area, to detect the intrusion into the intrusion path ahead.

A twenty fourth invention is the monitoring device according to any one of the thirteenth to twenty second inventions, wherein the first intrusion detecting terminal unit is provided on a wall-like structure. Thereby, the intrusion detecting terminal unit can be installed on the fence or the like.

A twenty fifth invention is the monitoring device according to the twenty fourth invention, wherein the wall-like structure is a handrail of the veranda. Thereby, the first intrusion detecting terminal unit can be installed on the handrail of the veranda.

A twenty sixth invention is the monitoring device according to any one of the thirteenth to twenty second inventions, wherein the first intrusion detecting terminal unit is installed on a floor of the veranda. Thereby, the intrusion into the veranda can be detected.

A twenty seventh invention is the monitoring device according to any one of the thirteenth to twenty sixth inventions, wherein the second intrusion detecting terminal unit is provided at an opening portion of the intrusion path to monitor. Thereby, the intruder getting into or out of the opening portion can be detected using the intrusion detecting terminal unit installed in a place into or out of the intrusion path.

A twenty eighth invention is the monitoring device according to the twenty seventh invention, wherein the opening portion is an opening/closing part of the window in the domicile. Thereby, the opening or closing of the window can be detected.

A twenty ninth invention is the monitoring device according to any one of the thirteenth to twenty eighth inventions, wherein at least the first intrusion detecting terminal unit is provided with a piezoelectric sensor. In the case where the first intrusion detecting terminal unit is installed on the veranda or fence, the intrusion can be detected by detecting rapidly a deformation due to a pressure where the intruder puts hand or foot on the handrail of the veranda or the fence, because the piezoelectric sensor outputs a voltage signal according to an acceleration of deformation due to the piezoelectric effect. Further, the piezoelectric sensor can be freely laid along the shape of handrail of the veranda or fence, because the piezoelectric sensor is like the cable having compliance.

A thirtieth invention is the monitoring device according to any one of the thirteenth to twenty ninth inventions, further comprising a third intrusion detecting terminal unit for photographing the intrusion path, wherein the third intrusion detecting terminal unit starts photographing if receiving an unsteady signal from the intrusion detecting terminal unit. Thereby, the intrusion path can be photographed by the third intrusion detecting terminal unit if the intruder is detected by the intrusion detecting terminal unit.

A thirty first invention is a program for enabling a computer to perform the functions of the monitoring device according to any one of the thirteenth to thirtieth inventions. Because of the program, at least a part of the monitoring system of the invention can be easily realized in cooperation with the hardware resources such as an electrical information apparatus, a computer and a server. Also, the program is recorded on a recording medium, or distributed via the communication line, whereby the distribution or update of the program, as well as its installation operation, can be simply made.

The embodiments of the present invention will be described below with reference to the drawings. The invention is not limited to the embodiments.

### EMBODIMENT 1

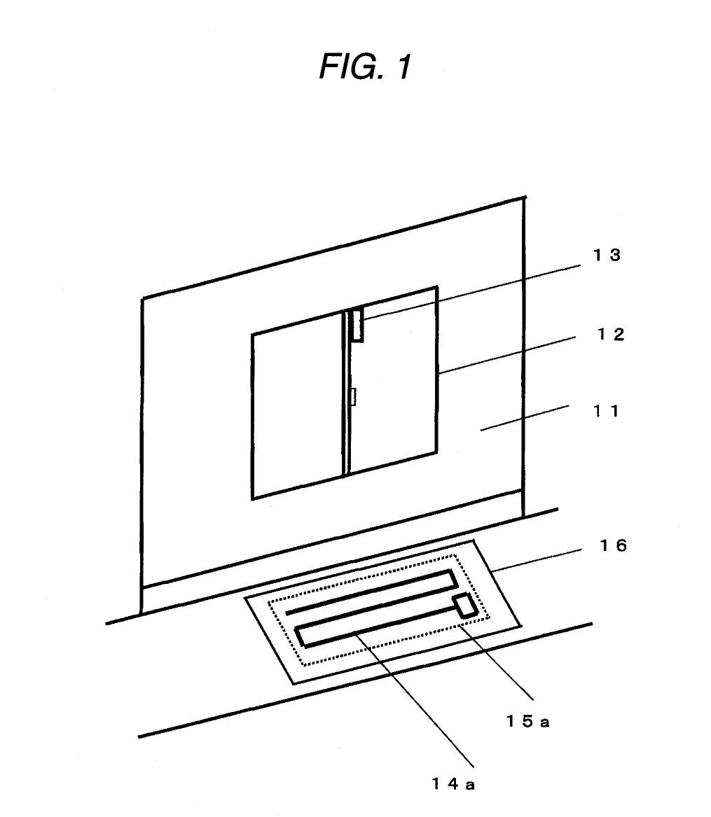

FIG. 1 is a constitutional view of a domicile having installed a monitoring device according to a first embodiment of the invention.

In FIG. 1, reference numeral 11 denotes a house, and reference numeral 12 denotes a window, in which an intrusion detecting terminal unit 13 having an opening/closing sensor is installed. Reference numeral 15a denotes a piezoelectric sensor terminal unit having a piezoelectric sensor 14a. Reference numeral 16 denotes a mat containing the intrusion detecting terminal unit 15a with the piezoelectric sensor.

Though in the embodiment 1 the cable-like piezoelectric sensor as the intrusion detection sensor is built into the mat, the piezoelectric sensor may be built in other members such as artificial lawn, shed or stepping-stone than the mat, thereby achieving the same effect.

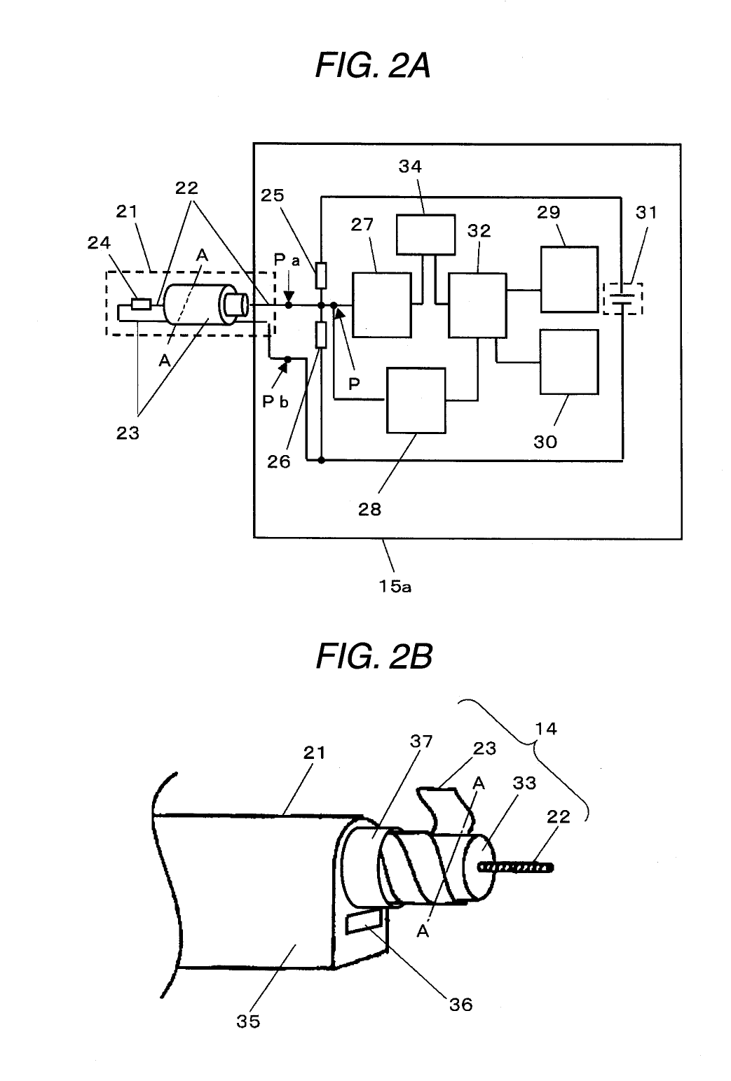

FIG. 2A is an internal block diagram of the piezoelectric sensor terminal unit 15a. Reference numeral 21 denotes an intrusion detection part, in which the piezoelectric sensor 14 with compliance is disposed in an elastic body 35, as shown in FIG. 2B. The piezoelectric sensor 14 generates an output signal in accordance with a deformation. The elastic body 35 is made of an elastic material such as rubber having more excellent flexibility and compliance than the piezoelectric sensor 14, so that the piezoelectric sensor 14 may be easily deformed due to a pressure where the intruder tries to enter the dwelling from the window and steps on the mat under the window, and chosen in view of the heat resistance and cold resistance for outdoor installation, although it is built into the mat. Specifically, the material that is scarcely degraded in compliance from −30° to 85° C. is preferably chosen. Such rubbers may include ethylene propylene rubber (EPDM), chloroprene rubber (CR), butyl rubber (IIR), silicone rubber (Si), and thermoplastic elastomer. Also, the elastic body 35 is formed hollow, and has a buffer part 36 that is compressible by pressure. With this constitution, if the buffer part 36 is provided on the upper face of the mat, namely, on the opposite side of a pressure receiving face, the piezoelectric sensor is more likely to deform due to a force applied from the mat and can produce a greater output. Also, the adequate buffer part may be provided on the upper face of the mat 16, whereby the piezoelectric sensor has more durability so that even if an impact is applied by the step or an object with acute tip, a part of the piezoelectric sensor 14a built in is invulnerable. A fixing method on the mat may involve fitting beforehand the intrusion detecting terminal unit 15a with the piezoelectric sensor into the mat, or employing an adhesive tape, or any other methods may be taken as far as the piezoelectric sensor can be firmly fixed to the mat. Reference numeral 22 denotes a center electrode, and reference numeral 23 denotes a ground electrode. Reference numeral 24 denotes a sensor side resistor provided as a resistor for detecting a wire disconnection between the center electrode 22 and the ground electrode 23 at an end portion of the piezoelectric sensor 14a. Reference numeral 25 denotes a circuit side resistor for detecting a wire disconnection. Reference numeral 26 denotes a signal deriving resistor for deriving a signal from the piezoelectric sensor 14a. Reference numeral 27 denotes a filter part for passing only a predetermined frequency component from the output signal of the piezoelectric sensor 14a. Reference numeral 28 denotes an abnormality determination part for determining a disconnection failure from the piezoelectric sensor 14a. Reference numeral 29 denotes data communication means for transmitting or receiving the person's presence or absence information or the opening or closing information of the window or door to or from the intrusion detecting terminal unit 13a with the opening/closing sensor. Reference numeral 30 denotes report means for raising the alarm or emitting the light to threaten the intruder, when the intrusion occurs. Reference numeral 31 denotes a battery. Reference numeral 32 denotes a terminal control part that sends the person's presence information, along with the terminal unit ID information of its own, to the intrusion detecting terminal unit 13 with the opening/closing sensor by wireless using the data communication means 29, when the intrusion detection part 21 detects a pressure. Also, when the failure detection part 28 detects a disconnection failure, the report means 30 makes a report. Reference numeral 33 denotes a piezoelectric layer. Reference numeral 34 denotes a comparator part for comparing the output signal of the filter part 27 with a preset value to determine the intrusion.

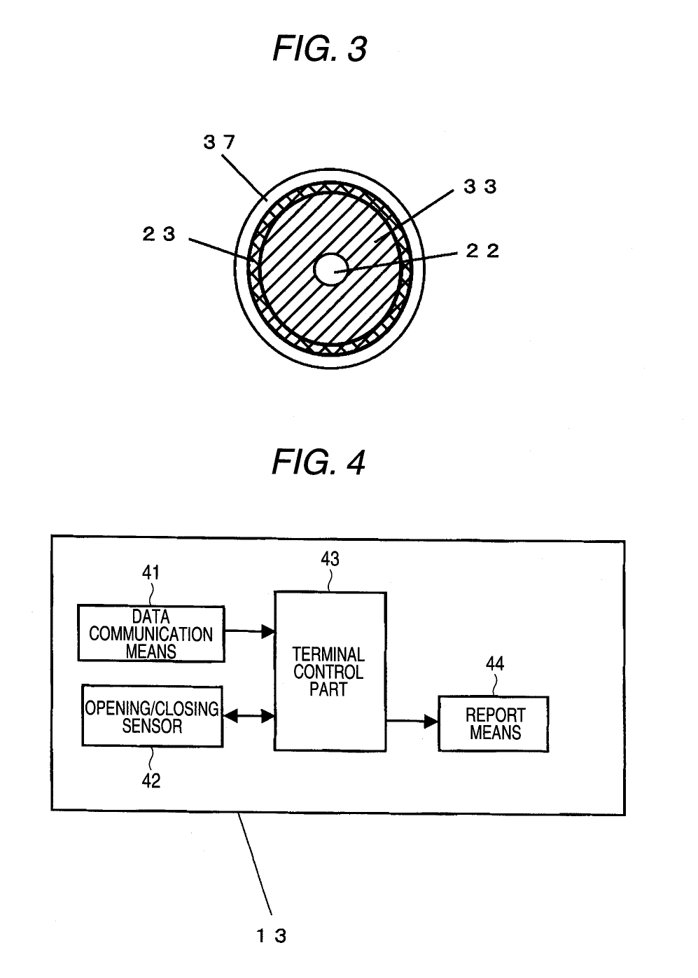

FIG. 3 is a cross-sectional view of the piezoelectric sensor 14a, taken along the line A-A in FIG. 2. In FIG. 3, reference numeral 22 denotes the center electrode, reference numeral 23 denotes the ground electrode, reference numeral 33 denotes the piezoelectric layer and reference numeral 37 denotes a covering layer.

The center electrode 22 may be a normal metallic solid conductor, but is the electrode having a metallic coil wound around an insulating polymeric fiber here. The insulating polymeric fiber and the metallic coil are preferably polyester fiber commercially available in the electric heating blanket and copper alloy containing 5 wt % of silver, respectively.

The piezoelectric layer 33 is typically made of a resin-based piezoelectric polymer such as polyvinylidene fluoride, and the high temperature durability is increased by using a piezoelectric compound in which a powder of piezoelectric ceramics is mixed into polymeric base material such as chlorinated polyethylene.

The ground electrode 23 is a strip electrode in which a metallic film is bonded on a polymeric layer, and is wound around the piezoelectric layer 33. And the polymeric layer is made of polyethylene terephthalate (PET). An electrode with an aluminum film bonded on the polymeric layer is preferable as the ground electrode 23, because it has a high thermal stability at 120° C., and is mass-produced commercially. To shield the piezoelectric sensor 14 from the electrical noise of external environment, it is preferable that the ground electrode 23 is wound around the piezoelectric layer 33 so as to partially overlap.

The covering layer 37 is made of polymeric material having adequate elasticity such as urethane, polyethylene or vinyl chloride.

FIG. 4 is an internal block diagram of the intrusion detecting terminal unit 13 with the opening/closing sensor. As shown in FIG. 4, the intrusion detecting terminal unit 13 with the opening/closing sensor has integrally an intrusion detection part and a control part. Reference numeral 41 denotes data communication means for transmitting or receiving the person's presence or absence information or the opening/closing information of the window or door to or from the piezoelectric sensor terminal unit 15a. Reference numeral 42 denotes an intrusion detection part for detecting the opening/closing of the window or door in such a manner that a reed switch is provided, the intrusion detecting terminal unit 13 with the opening/closing sensor is mounted on a frame of the window or door, and a magnet acting for opening or closing corresponding to the reed switch is affixed on a window glass or door opening/closing part that is a movable part. Reference numeral 43 denotes a terminal control part that sends the opening/closing information in opening or closing the window or door, along with the terminal unit ID information of its own, to the intrusion detecting terminal unit 15a with the piezoelectric sensor by wireless using the data communication means 41. Reference numeral 44 denotes report means for making a report to the outside when the window or door is opened.

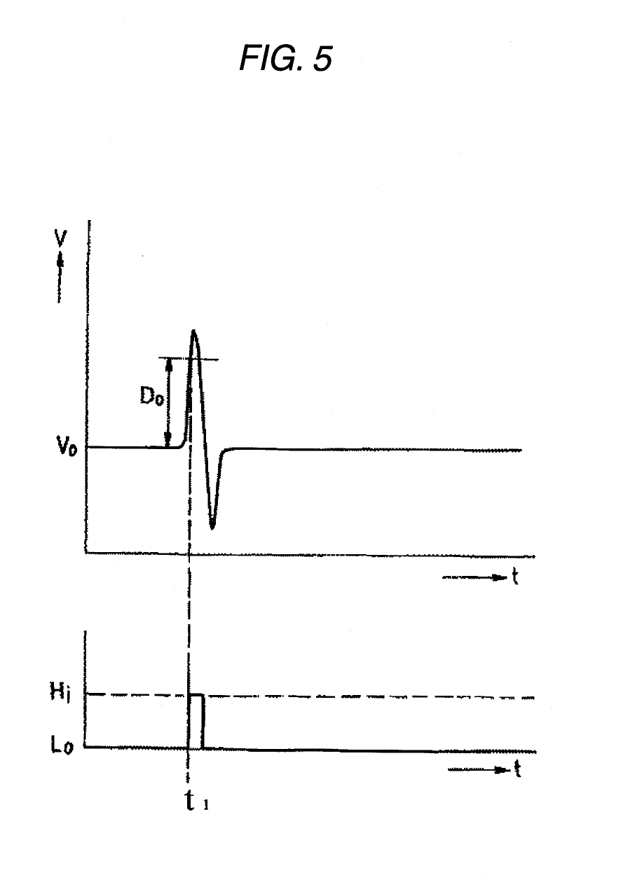

Referring to FIG. 5, the operation and action of the monitoring device with the above configuration will be described below.

First of all, an instance where the intruder attempts to intrude into the house 11 will be described below. If the intruder tries to intrude into the house 11 from the window 12, the intruder steps on the mat 16, and intrudes by breaking the window 12. At this time, the piezoelectric sensor 14a built in the mat 16 is deformed due to a pressure where the intruder steps on the mat 16.

A signal according to an acceleration of deformation of the piezoelectric sensor 14a due to the piezoelectric effect is outputted from the piezoelectric sensor 14a.

FIG. 5 shows the output signal V of the filter part 27. When the person treads on the mat 16, a signal component greater than the reference potential V0 appears in V. The piezoelectric sensor 14a attains a large deformation amount, and the acceleration that is the secondary differential value of the deformation amount is increased, so that the output signal of the piezoelectric sensor 14a is greater. The comparator part 34 determines that the person treads on the mat 16, if the amplitude |V−V0| of V from V0 is larger than D0, and outputs a pulse signal of L0→Hi→L0 as the determination output at time t1.

If the pulse signal of intrusion determination is outputted from the comparator part 34, the terminal control part 32 periodically sends the person's presence information, along with the terminal unit ID information of its own, to the intrusion detecting terminal unit 13 with the opening/closing sensor by wireless using the data communication means 29. Further, the report means 30 makes a report (first report) for drawing the attention. This report does not have so large a sound volume as to be heard to the neighboring area, but has a sound volume large enough to be heard only in the vicinity.

And when the intruder tries to further trespass on the premises and opens the window 12, the intrusion detecting terminal unit 13 with the opening/closing sensor detects the opening of the window 12, and based on the person's presence information received from the intrusion detecting terminal unit 15a with the piezoelectric sensor, the intrusion detecting terminal unit 13 with the opening/closing sensor judges that the intrusion occurs and raises an alarm of large sound volume (second report) from the report means to threaten the intruder. At this time, the intrusion detecting terminal unit 13 with the opening/closing sensor may send the opening information to the intrusion detecting terminal unit 15a with the piezoelectric sensor, and then the intrusion detecting terminal unit 15a with the piezoelectric sensor may also raise an alarm of large sound volume.

When the user opens the window 12 for ventilation inside the house, the intrusion detecting terminal unit 13 with the opening/closing sensor does not raise the alarm, because it has not received the person's presence information from the intrusion detecting terminal unit 15a with the piezoelectric sensor.

Next, a procedure for disconnection determination in the abnormality determination part 28 will be described below. In FIG. 3A, it is assumed that the resistance values of the sensor side resistor 24, the circuit side resistor 25 and the signal deriving resistor 26 are R1, R2 and R3, the voltage at point P is Vp and the voltage of the battery 31 is Vs. R1, R2 and R3 usually have resistance values of several mega to several tens mega ohms. When the electrode of the piezoelectric sensor 14 is normal, Vp is equal to a partial voltage of Vs at a ratio of the parallel resistance of R2 and R3 to R1. Herein, since the resistance value of the piezoelectric layer 33 is usually several hundreds mega ohms or more, it hardly contributes to the parallel resistance value of R2 and R3, and is ignored in calculating the partial voltage value. If the electrode of the piezoelectric sensor 14 is disconnected, the point Pa or Pb is equivalently opened, so that Vp becomes a partial voltage value of R2 to R3. If the electrode is short-circuited, the points Pa and Pb are equivalently short-circuited, so that Vp is equal to Vs. In this manner, the abnormality determination part 28 detects a failure such as a disconnection or short-circuit of the electrode for the piezoelectric sensor 14, based on the value of Vp, whereby the reliability is improved.

As described above, in the embodiment 1, the piezoelectric sensor terminal unit is installed under the window, and the opening/closing sensor terminal unit is installed on the window. If the intruder tries to intrude from outdoors and opens the window, it is judged that the intrusion occurs. On the contrary, if the window is opened from indoors, it is judged that the user opens the window. Thereby, the user does not need to perform an operation of turning off the power of the opening/closing sensor terminal unit, every time of opening the window. The intruder is threatened by the report means and discouraged from intrusion.

Also, when the person's presence is detected by the piezoelectric sensor terminal unit, a report for drawing the attention is given, whereby there is less disaster of breaking the window. Further, since the sound volume of alarm is so large as to be heard at the spot, it will not cause trouble to the neighboring area even when the tread of small animal is detected. Also, it is possible to make the adjustment so that the person may be detected but the small animal may not be detected by changing the value of D₀ as shown in FIG. 5, whereby the more reliable monitoring device can be provided.

Also, since the intrusion detection sensor comprises the cable-like piezoelectric sensor having compliance, and the piezoelectric sensor outputs a voltage signal according to an acceleration of deformation due to the piezoelectric effect, a deformation due to a pressure where the intruder steps on the mat can be detected rapidly, and the piezoelectric sensor can be freely laid down along the shape of various building materials, because the piezoelectric sensor is like the cable having compliance.

Though in the embodiment 1, the opening/closing sensor terminal unit for detecting the opening or closing of the window or door is employed by providing the reed switch to detect the intrusion through the window or door, and affixing the magnet for opening or closing corresponding to the reed switch to the window glass or door opening/closing part that is the movable part, a vibration sensor terminal unit for detecting the vibration of the window, or a touch sensor terminal unit with a pyroelectric sensor may be also employed to achieve the same effect.

Also, though in the embodiment 1 the communication medium is wireless, any communication media such as wire telecommunications with dedicated line, lamp line carrier communications, infrared communications, or fiber optics communications may be employed to achieve the same effect.

### EMBODIMENT 2

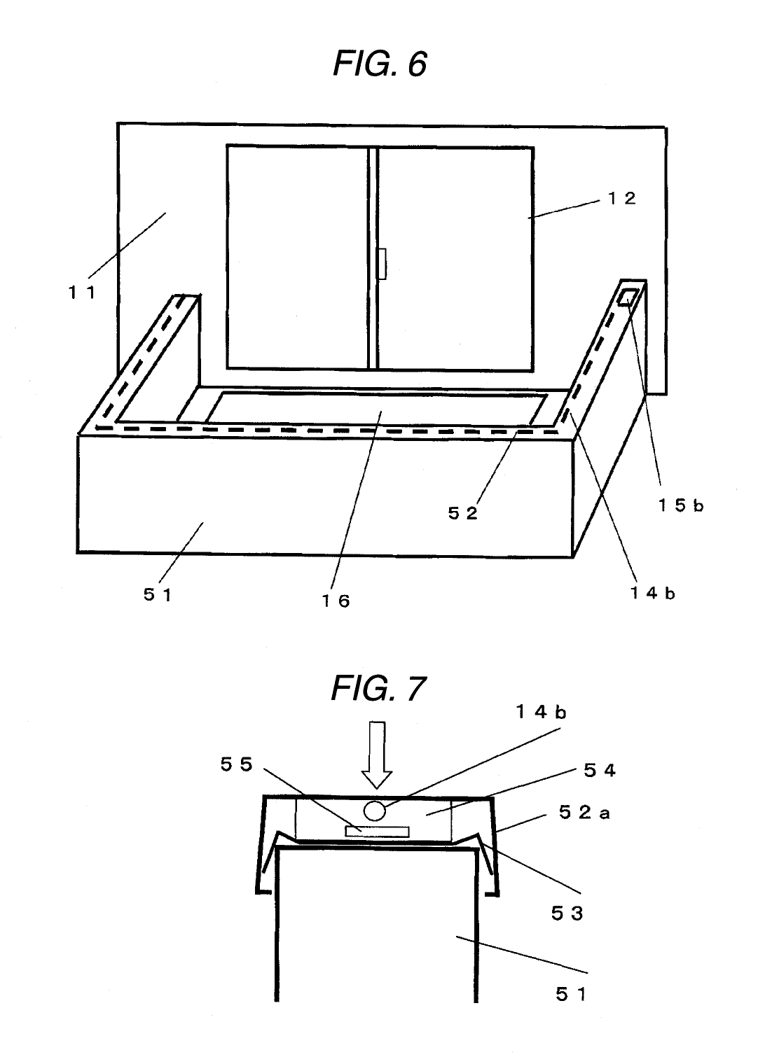

FIG. 6 shows a domicile having installed a monitoring device according to a second embodiment 2 of the invention. A handrail 52 is mounted on a wall-like structure 51 of the veranda for the housing 11. On this handrail 52, an intrusion detecting terminal unit 15b with the piezoelectric sensor is provided in a state where the cable-like piezoelectric sensor is disposed on the upper face of the handrail. And the mat 16 is laid under the window 12 and provided with an intrusion detecting terminal unit 15a with the piezoelectric sensor having the same constitution as in the embodiment 1. FIG. 7 shows a constitution in which the piezoelectric sensor 14b is mounted on the handrail 52. A handrail cover 52a is laid on the upper face of the wall-like structure 51 of the veranda, and support means 54 is carried between an auxiliary fixture 53 for handrail cover and it on the bottom and inside of the handrail cover 52a, in which the piezoelectric sensor 14b and a buffer part 55 are contained in this support means 54. The constitution of the cable-like piezoelectric sensor provided on the handrail as in this embodiment is shown in FIG. 2B, but the support means 54 and the buffer part 55 may be provided to conform to the shape of the handrail 52 as explained in this embodiment and shown in FIG. 7. For example, if the handrail has the roundish shape, the support means 52 and the buffer part 55 are rounded to be easily combined, whereby the support means is carried more easily.

The operation and action of the monitoring device with the above configuration will be described below.

First of all, an instance where the intruder attempts to intrude into the house will be described below. If the intruder tries to intrude into the house from the veranda, and get over the veranda (wall-like structure 51) by putting hand or foot on the veranda (wall-like structure 51), a pressure is exerted on the handrail 52 of the veranda, and applied through the handrail cover 52a to the piezoelectric sensor 14b and the support means 54. The upper face of the supper means 54 is closely attached on the handrail cover 52a and the lower face is closely attached on the handrail (cover) auxiliary fixture 53. Further, since the support means 54 has more flexibility than the piezoelectric sensor 14b, the support means 54 is compressed by the pressure, so that the piezoelectric sensor 14b is deformed. And a signal according to an acceleration of deformation of the piezoelectric sensor 14a due to the piezoelectric effect is outputted from the piezoelectric sensor 14b, whereby it is detected that the handrail 52 of the veranda is pressed. The veranda sensor sends the detection information, along with the terminal unit ID information of its own, to the intrusion detecting terminal unit 15a with the piezoelectric sensor provided in the mat 16 under the window 12 by wireless using the data communication means. Further, the report means makes a report for drawing the attention. This report does not have so large a sound volume as to be heard to the neighboring area, but has a sound volume large enough to be heard only in the vicinity. And when the intruder intrudes into the veranda and steps on the mat 16, the piezoelectric sensor 14a built in the mat 16 is deformed due to a pressure where the intruder treads on the mat 16a. A signal according to an acceleration of deformation of the piezoelectric sensor 14a due to the piezoelectric effect is outputted from the piezoelectric sensor 14a built in the mat 16, whereby it is detected that the mat 16 is pressed. The intrusion detecting terminal unit 15a provided in the mat 16 under the window has already received the detection information from the intrusion detecting terminal unit 15b provided on the handrail of the veranda, and judges that the intrusion occurs, whereby the report means raises an alarm of large sound volume to threaten the intruder.

Next, when the user gets out of the house to the veranda to hang out the washing on the veranda, the report means does not raise the alarm, because the intrusion detecting terminal unit 15a under the window has not received the detection information from the intrusion detecting terminal unit 15b of the veranda. Therefore, even when the user gets out to the veranda, the user does not need to perform an operation of turning off the power to prevent false detection of the monitoring device for the intruder, or false alarm of the report means by forgetting to turn off the power.

### EMBODIMENT 3

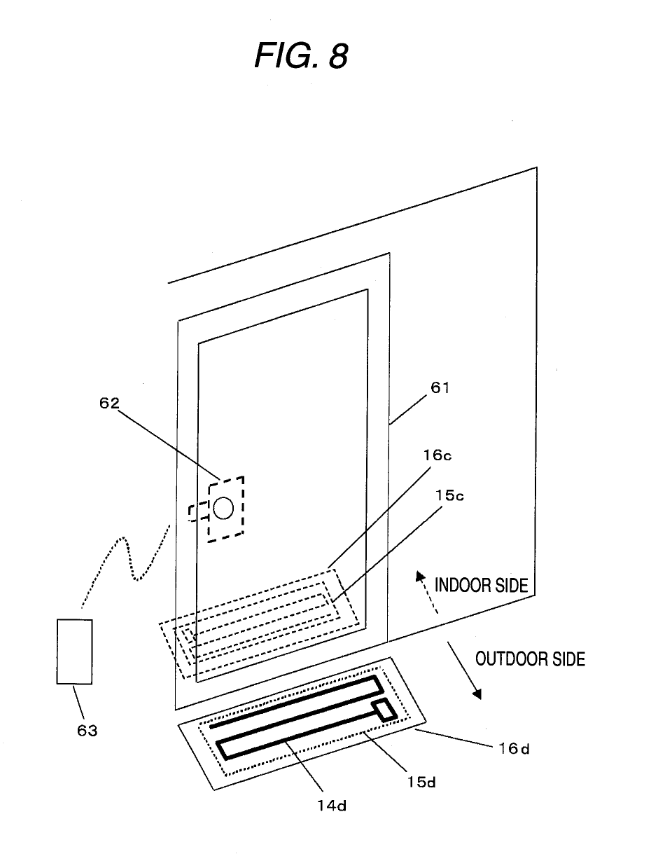

FIG. 8 shows the constitution of a porch having installed a monitoring device according to a third embodiment of the invention.

In FIG. 8, reference numeral 61 denotes a porch door, and reference numeral 62 denotes a lock device. The lock device 62 is installed inside the porch door 61. Reference numerals 15c, 15d denote the piezoelectric sensor terminal units having piezoelectric sensors 14c, 14d. Reference numerals 16c, 16d denote the mats with the piezoelectric sensor terminal unit built in, which are installed on the outdoor side and the indoor side of the porch. Reference numeral 63 denotes a remote control terminal unit that the user carries, in which communication means makes the wireless communication between the lock device 62 and the remote control terminal unit 63.

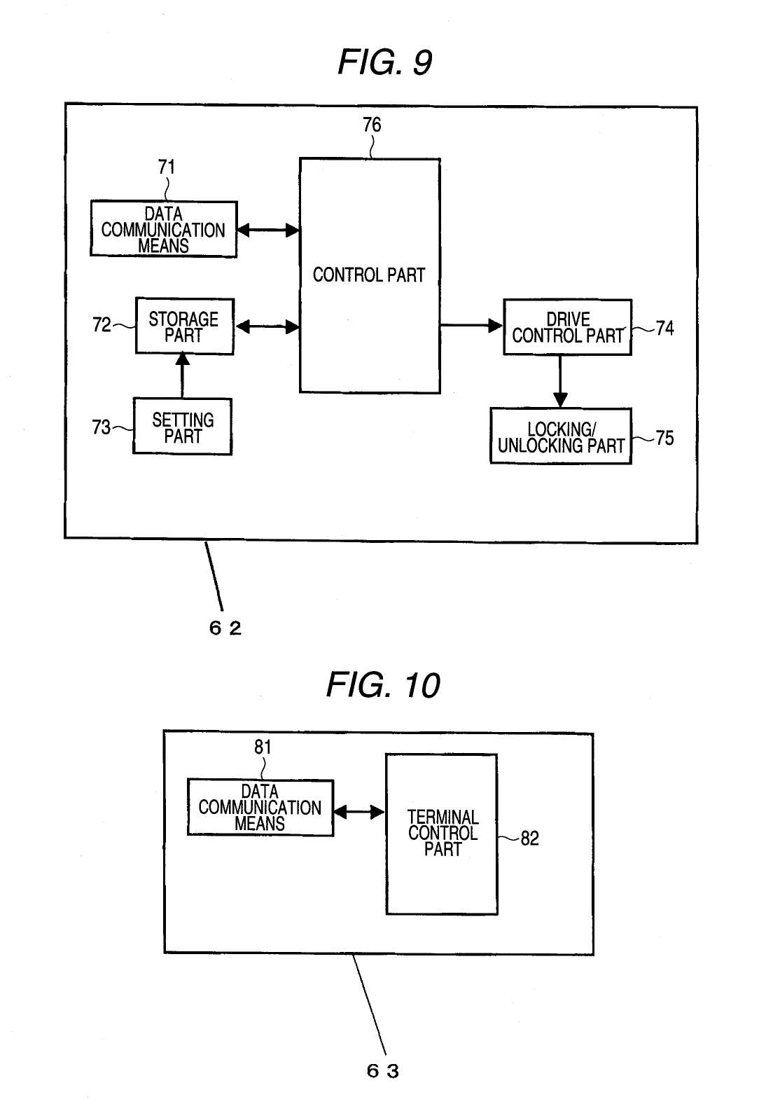

FIG. 9 is a block diagram of the lock device. Reference numeral 71 denote data communication means for transmitting or receiving the terminal unit ID information with the remote control terminal unit 63. Reference numeral 72 denotes a storage part for storing the ID information of the remote control terminal unit 63. Reference numeral 73 denotes a setting part that is used to input the ID information of the remote control terminal unit 63. As the operation method, the ID information is directly inputted with the ten key, or a switch is provided and pressed to make the communication with the remote control terminal unit to store the ID information. Reference numeral 74 denotes a drive control part for driving a locking/unlocking part 75 for locking or unlocking the door upon receiving a locking signal or unlocking signal from a control part 76. Also, the control part 76 judges whether or not the received terminal unit ID information is matched with the terminal unit ID information stored in the storage part 72 if receiving the terminal unit ID information from the remote control terminal unit using the data communication means 71.

FIG. 10 is an internal block diagram of the remote control terminal unit. Reference numeral 81 denotes data communication means capable of communicating with the lock device 62 by wireless to transmit the terminal unit ID information. Reference numeral 82 denotes a terminal control part.

The operation and action of the monitoring device with the above configuration will be described below.

First of all, an instance where the user tries to go out carrying the remote control terminal unit 63. The remote control terminal unit 63 transmits the terminal unit ID information periodically, for example, at an interval of 0.5 seconds. If the user comes closer to the door 61 carrying the remote control terminal unit 63, the lock device 62 receives the terminal unit ID information, and judges whether or not the received terminal unit ID information is matched with the terminal unit ID stored in the storage part 72.

And when the user treads on the mat 16c on the indoor side where the piezoelectric sensor terminal unit 15c is built in, the piezoelectric sensor terminal unit 15c detects the person's presence, and sends the person's presence information to the lock device 62.

And if the terminal unit ID information of the remote control terminal unit 63 is matched with the stored terminal unit ID, the lock device 62 unlocks the door 61 upon receiving the person's presence information from the piezoelectric sensor terminal unit 15c. Herein, if the terminal unit ID information is unmatched, the door 61 is not unlocked.

And when the user treads on the mat 16d installed on the outdoor side and then goes away, the mat 16d sends the person's absence information to the lock device 62, and the lock device 62 locks the door 61. Also, the lock device receives the person's presence information from the mat 16c provided on the indoor side to unlock the door, and thereafter judges that the person goes away based on the person's absence information from the mat 16d.

When the user comes home, the door 61 is unlocked and locked in the same manner although the order of detection on the mat is the reverse order at the time of going away, whereby it is judged that the person comes home.

As described above, in the embodiment 3, when the user approaches the door carrying the remote control terminal unit, the door can be automatically unlocked or locked, whereby the user does not need to lock or unlock the door by taking out the key every time.

Also, with the above operation, since the lock device can judge whether the user goes out or comes home, even when the user comes home and leaves the remote control terminal unit in the porch, and another person is detected by the piezoelectric sensor terminal unit on the outdoor side of the porch, the door may not be unlocked, because the lock device judges that the user comes home, whereby the user can use the monitoring device at rest.

Though in the embodiment 3, the piezoelectric sensor is built in the mat, the piezoelectric sensor may be attached to a doorknob part of the door, or an operating portion of the doorknob, whereby the person's presence or absence state can be detected depending on whether or not the person touches the doorknob of the door to go away or come home.

### EMBODIMENT 4

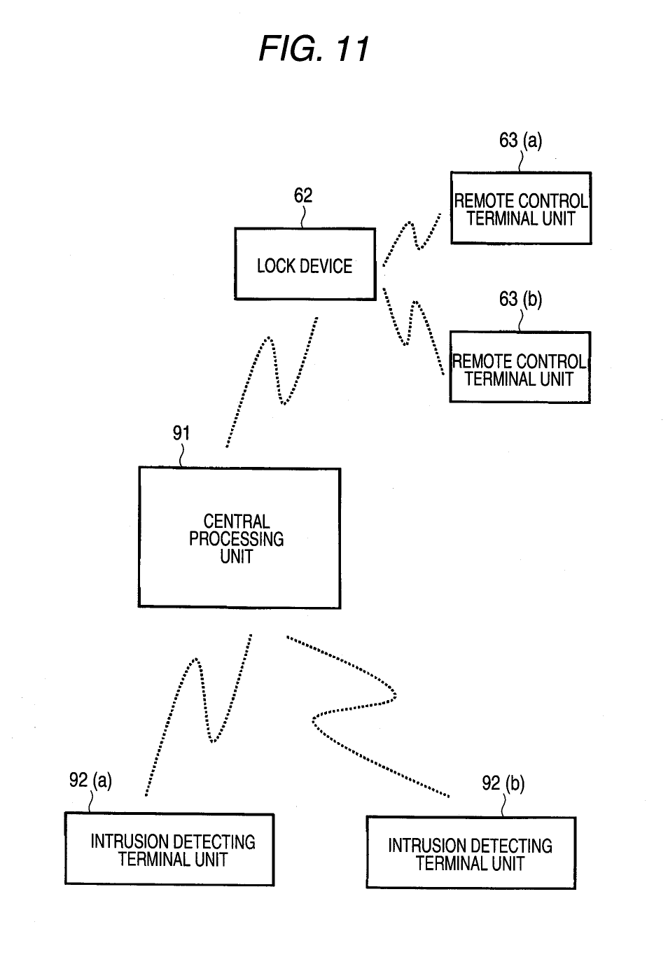

FIG. 11 is a system block diagram of a monitoring device according to an embodiment 4 of the invention.

In FIG. 11, the monitoring device comprises a lock device 62, a central processing unit 91, the intrusion detecting terminal units 92(a) and 92(b), and the remote control terminal units 63(a) and 83(b). Communication means makes the wireless communications between the central processing unit 91 and the lock device 62, between the central processing unit 91 and the intrusion detecting terminal units 92(a), 92(b), and between the lock device and the remote control terminal units 63(a), 63(b). Herein, the intrusion detecting terminal units 92 have the same configuration as the opening/closing sensor terminal unit as shown in FIG. 4. The opening/closing sensor 42 detects the person's presence by mounting a pyroelectric sensor, or detects the opening or closing of the window by mounting a reed switch to detect the intruder. Also, the communication means 41 makes the data communication with the central processing unit 91. If the intrusion is detected, the report means 44 raises an alarm for threat.

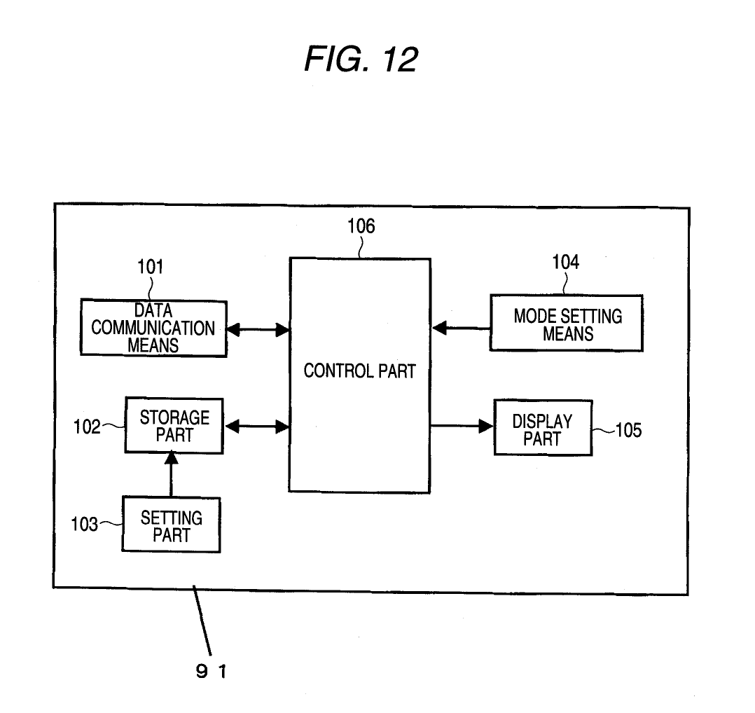

FIG. 12 is an internal block diagram of the central processing unit 91. In FIG. 12, reference numeral 101 denotes data communication means, which transmits or receives the coming home or going out information of the user from the lock device 62, and the start or release information of the monitoring operation for the intrusion detecting terminal units 92. Reference numeral 102 denotes a storage part for storing the terminal unit IDs of a plurality of remote control terminal units. Reference numeral 103 denotes a setting part that is used to input the terminal unit ID of the remote control terminal unit. Reference numeral 104 denotes mode setting means for setting a first mode (hereinafter referred to as a going-out warning mode) in which the monitoring operation for all the intrusion detecting terminal units is started and a second mode (hereinafter referred to as an at-home warning mode) in which the monitoring operation for some of the intrusion detecting terminal units is started. Reference numeral 105 denotes a display part for making a display in setting the mode or inputting the terminal unit ID. Reference numeral 106 denotes a control part for controlling the data communication means 92, the storage part 93 and the display part 96.

The operation and action of the monitoring device with the above configuration will be described below.

First of all, an instance where the user goes out carrying the remote control terminal unit 63(a) will be described below. When the user goes out, the lock device 62 can judge that the user goes out, and transmits the terminal unit ID information of the remote control terminal unit 63(a) and the going-out information to the central processing unit 91.

The central processing unit 91 receives the going-out information, judges that the user goes out, and transmits the monitoring operation start information to the intrusion detecting terminal units 92(a) and 92(b) to start the monitoring operation of the intrusion detecting terminal units 92(a) and 92(b).

The intrusion detecting terminal units 92(a) and 92(b) start the monitoring operation. At this time, if the intrusion detection part 42 detects the person or the opening or closing the window, the report means 44 raises an alarm.

Next, an instance where the user comes home carrying the remote control terminal unit 63(a) will be described below. When the user comes home, the lock device 62 can judge that the user comes home, and transmits the terminal unit ID information of the remote control terminal unit 63(a) and the coming-home information to the central processing unit 91.

The central processing unit 91 receives the coming-home information, judges that the user comes home, and transmits the monitoring operation release information to the intrusion detecting terminal units 92(a) and 92(b) to release the monitoring operation of the intrusion detecting terminal units 92(a) and 92(b).

The intrusion detecting terminal units 92(a) and 92(b) release the monitoring operation. At this time, even if the intrusion detection part 42 detects the person or the opening or closing of the window, the report means 44 raises no alarm.

Next, an instance where there are two or more users, each carrying the remote control terminal unit will be described below about the operation.

First of all, in the case where two users (users (a) and (b)) exist and both reside in the house, the intrusion detecting terminal units 92(a) and 92(b) release the monitoring operation.

And if the user (a) goes away, carrying the remote control terminal unit 63(a), the lock device 62 transmits the terminal unit ID information of the remote control terminal unit 63(a) and the going-out information to the central processing unit 91.

The central processing unit 91 judges that the remote control terminal unit 63(a) (user (a)) goes away, sets up an at-home warning mode, and transmits the monitoring operation start information to only the intrusion detecting terminal unit (here the intrusion detecting terminal unit 92(a)) desired to start the monitoring operation. This is employed in the case where two persons of parent and child reside in the house, in which when the parent goes out, the intrusion detecting terminal unit alone for detecting the opening or closing of the window, which is provided with the reed switch in the intrusion detection part 42 and installed in the window, is started for the monitoring operation, and because the child is still in the house, the intrusion detecting terminal unit installed in the corridor, with the pyroelectric sensor in the intrusion detection part 42, should not be started for the monitoring operation.

And if the user (b) goes out, carrying the remote control terminal unit 63(b), the lock device 62 transmits the terminal unit ID information of the remote control terminal unit 63(b) and the going-out information to the central processing unit 91.

The central processing unit 91 judges that the remote control terminal unit 63(b) (user (b)) goes away (judges that all the persons go out), sets up a going-out warning mode, and transmits the monitoring operation start information to all the intrusion detecting terminal units 92(a) and 92(b).

Next, if the user (b) comes home, carrying the remote control terminal unit 63(b), the lock device 62 transmits the terminal unit ID information of the remote control terminal unit 63(b) and the coming-home information to the central processing unit 91.

The central processing unit 91 judges that the remote control terminal unit 63(b) (user (b)) comes home, sets up the at-home warning mode, and transmits the monitoring operation release information to the intrusion detecting terminal unit 92(b) (at this time, the intrusion detecting terminal unit 92(a) alone starts the monitoring operation).

And if the user (a) comes home, carrying the remote control terminal unit 63(a), the lock device 62 transmits the terminal unit ID information of the remote control terminal unit 63(a) and the coming-home information to the central processing unit 91.

The central processing unit 91 judges that the remote control terminal unit 63(a) (user (a)) comes home, and transmits the monitoring operation release information to the intrusion detecting terminal unit 92(a) to release the monitoring operation.

The going-out warning mode or the at-home warning mode may be set up in accordance with the situation of the user.

As described above, in the embodiment 4, even in the case where there are two or more users, the central processing unit makes the settings in advance in accordance with the going-out or at-home situation of each person, whereby when all the persons go out, the monitoring operation for all the intrusion detecting terminal units is started, or when some persons reside in the house, the monitoring operation for specific intrusion detecting terminal unit only is started. Therefore, since the monitoring operation is started or released in accordance with the conduct of the user, the user does not need to perform an operation every time of going out or coming home, and the ease-of-use is improved.

The means as explained in this embodiment may take the form of a program in cooperation with the hardware resources such as an electrical information apparatus, a computer or a server having a CPU (or microcomputer), RAM, ROM, a storage/recording device and an I/O unit. The program may be recorded on the recording medium such as magnetic media or optical media, or distributed using the communication line such as the Internet, whereby the distribution of new functions or renewal of functions, or the installation operation can be simplified.

Also, the monitoring device of the invention is not limited to the above embodiment, but various changes may be made thereto without departing from the spirit or scope of the invention.

### EMBODIMENT 5

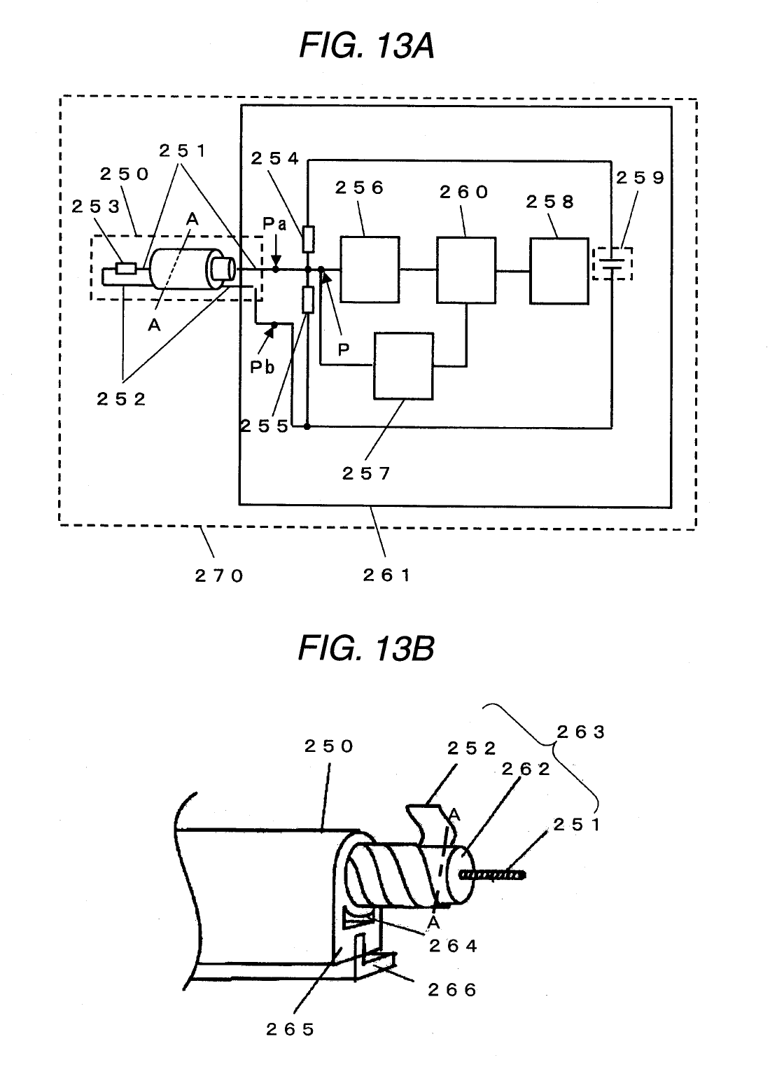

FIG. 13A is an internal block diagram of a piezoelectric sensor terminal unit for a monitoring device according to an embodiment 5 of the invention. In this embodiment, an instance where the piezoelectric sensor terminal unit is disposed on the fence around the house will be described below. Reference numeral 250 denotes an intrusion detection part, in which a piezoelectric sensor 263 with compliance is disposed in an elastic body 265, as shown in FIG. 13B. The piezoelectric sensor 263 generates an output signal in accordance with a deformation. The elastic body 265 is made of an elastic material such as rubber having more excellent flexibility and compliance than the piezoelectric sensor 263, so that the piezoelectric sensor 263 may be easily deformed by a pressure or vibration where the intruder tries to enter the house by getting over the fence and puts hand or foot on the upper part of the fence. Also, it is chosen in view of the heat resistance and cold resistance in installing the sensor outdoors. Specifically, the material that is scarcely degraded in compliance from −30° to 85° C. is preferably chosen. Such rubbers may include ethylene propylene rubber (EPDM), chloroprene rubber (CR), butyl rubber (IIR), silicone rubber (Si), and thermoplastic elastomer. Also, the elastic body 265 is formed hollow, and has a buffer part 264 that is compressible by pressure. Further, a groove portion to fix and support the elastic body on the fence 266 is formed on the bottom of the elastic body 265. A fixing method on the upper part of the fence may involve fitting it into the upper part of the fence, or employing an adhesive tape, or any other methods may be taken as far as it can be firmly fixed on the fence. Also, the disposition position is not limited to the upper part of the fence, but may be on the front part of the fence, as far as the vibration can be detected. Reference numeral 251 denotes a center electrode. Reference numeral 252 denotes a ground electrode. Reference numeral 253 denotes a sensor side resistor provided as a resistor for detecting a wire disconnection between the center electrode 251 and the ground electrode 252 at an end portion of the piezoelectric sensor 263. Reference numeral 254 denotes a circuit side resistor for detecting a wire disconnection. Reference numeral 255 denotes a signal deriving resistor for deriving a signal from the piezoelectric sensor 263. Reference numeral 256 denotes a filter part for passing only a predetermined frequency component from the output signal of the piezoelectric sensor 263. Reference numeral 257 denotes an abnormality determination part for determining a disconnection failure from the piezoelectric sensor 263. Reference numeral 258 denotes a report part for raising the alarm or emitting the light to threaten the intruder, when the intrusion occurs. Reference numeral 259 denotes a battery. Reference numeral 260 denotes a terminal control part that controls the report part 258 to threaten the intruder when the intrusion detection part 250 detects a pressure or vibration. Also, when a disconnection failure is detected by the abnormality determination part 257, the report part 358 gives a report. Reference numeral 261 denotes determination means. Reference numeral 262 denotes a piezoelectric layer.

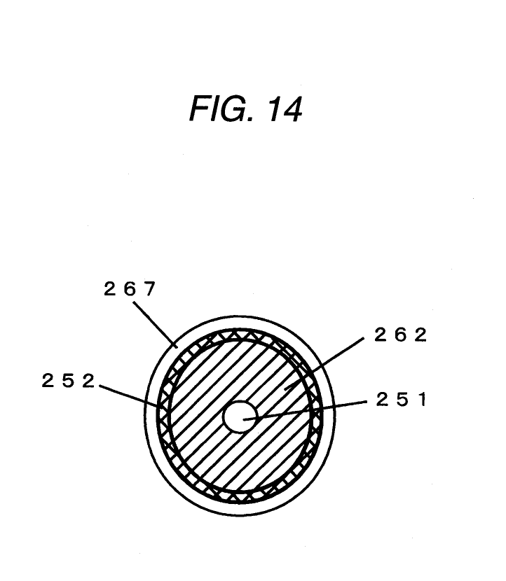

FIG. 14 is a cross-sectional view of the piezoelectric sensor 263, taken along the line A-A in FIG. 13. In FIG. 14, reference numeral 251 denotes the center electrode. Reference numeral 252 denotes the ground electrode. Reference numeral 262 denotes the piezoelectric layer. Reference numeral 267 denotes a covering layer.

The center electrode 251 may be a normal metallic solid conductor, but is the electrode having a metallic coil wound around an insulating polymeric fiber here. The insulating polymeric fiber and the metallic coil are preferably polyester fiber commercially available in the electric heating blanket and copper alloy containing 5 wt % of silver, respectively.

The piezoelectric layer 262 is typically made of a resin-based piezoelectric polymer such as polyvinylidene fluoride, and the high temperature durability is increased by using a piezoelectric compound in which a powder of piezoelectric ceramics is mixed into polymeric base material such as chlorinated polyethylene.

The ground electrode 252 is a strip electrode in which a metallic film is bonded on a polymeric layer, and is wound around the piezoelectric layer 252. And the polymeric layer is made of polyethylene terephthalate (PET). An electrode with an aluminum film bonded on the polymeric layer is preferable as the ground electrode 252, because it has a high thermal stability at 120° C., and is mass-produced commercially. To shield the piezoelectric sensor 263 from the electrical noise of external environment, it is preferable that the ground electrode 252 is wound around the piezoelectric layer 262 so as to partially overlap.

The covering layer 267 is made of polymeric material having adequate elasticity such as urethane, polyethylene or vinyl chloride.

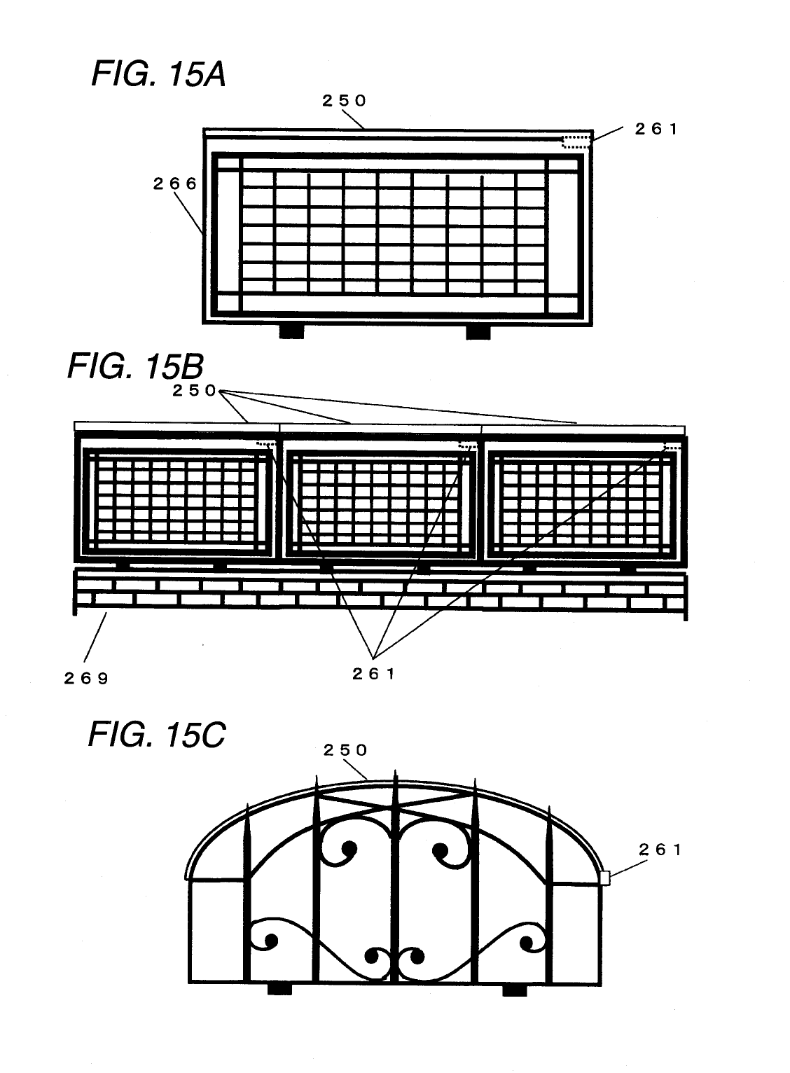

FIG. 15 shows a fence structure where the piezoelectric sensor terminal unit is disposed on the fence.

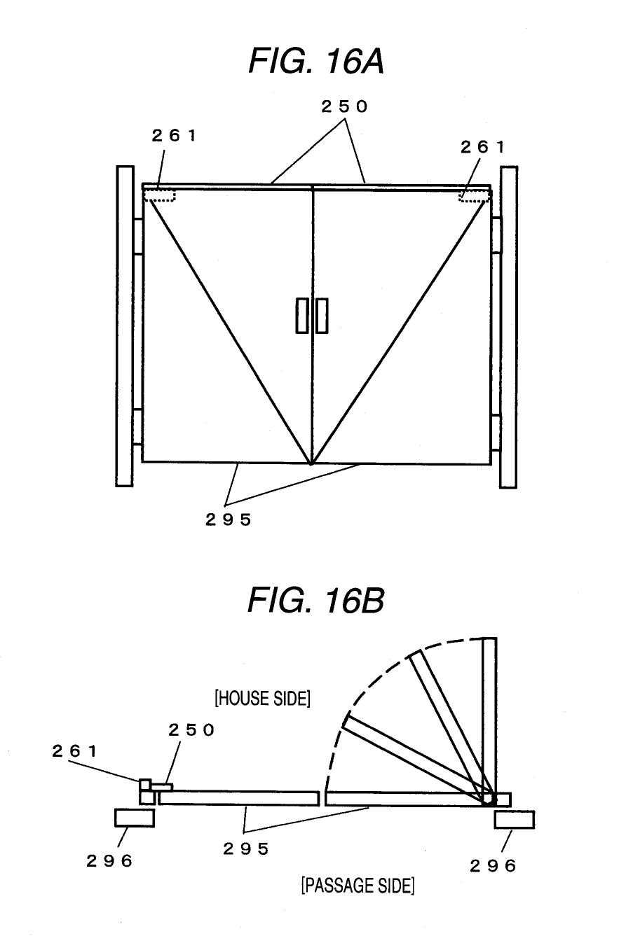

In FIG. 15A, reference numeral 266 denotes a single fence. The fence around the dwelling is installed by arranging the single fences 266 on a block fence 269, as shown in FIG. 15B. Reference numeral 250 denotes the intrusion detection part consisting of the piezoelectric sensor 263. The intrusion detection part is disposed for every single fence 266. Also, even if the upper part of the fence is curved as shown in FIG. 15C, or there are no fences extending straight in the horizontal direction, the sensor can be disposed along the shape of the fence, irrespective of the shape of the fence emphasizing the design, because the intrusion detection part 250 has compliance, whereby the degree of freedom in disposition is increased without spoiling the beauty. Also, the sensor may be disposed on a gate door, in which the sensor is disposed on the upper part of the gate door, like the fence, as shown in FIG. 16A, or disposed to detect the opening of the gate door in such a manner that the intrusion detection part 250 is bent when the gate door is opened or closed, as shown in FIG. 16B. Reference numeral 261 denotes determination means that is disposed on a fence face on the side of the house.

The operation and action of the monitoring device with the above configuration will be described below. In the following explanation, an instance of the fence installed around the dwelling is presented, but another fence, for example, having a fence structure with a barbed wire attached between the struts, may be likewise applied. First of all, the fence surrounding the house is usually installed by arranging the fences having a width of about 1 m, like the single fence 266 as shown in FIG. 15A, on the block fence 269 as shown in FIG. 15B. And for each single fence 266, the intrusion detection part 251 composed of the piezoelectric sensor 263 is disposed on the upper part of the fence. Next, when the intruder tries to steal into the premises and get over the fence, the intruder puts hand or foot on the intrusion detection part 251 disposed on the fence 266, so that the piezoelectric sensor 263 is deformed to generate an output signal. And the terminal unit control part 260 of the determination means 261 controls the report part 258 to threaten the intruder by the alarm or light. In this manner, a piezoelectric sensor terminal unit 270 is disposed for each fence 266, so that the intrusion place can be specified, whereby if the alarm is raised, the user can go to the scene immediately to take action. Also, since the alarm may be raised for the intruder at the intrusion place, the threatening effect is great. However, with a structure that the intrusion detection part of one cable is disposed on the fence, the intrusion place can not be specified, and the alarm may not be sounded near the intruder, even if the alarm is raised, whereby the effect of the monitoring device was small.

Next, a procedure for disconnection determination in the abnormality determination part 257 will be described below. In FIG. 13A, it is assumed that the resistance values of the sensor side resistor 253, the circuit side resistor 254 and the signal deriving resistor 255 are R1, R2 and R3, the voltage at point P is Vp and the voltage of the battery 259 is Vs. R1, R2 and R3 usually have resistance values of several mega to several tens mega ohms. When the electrode of the piezoelectric sensor 263 is normal, Vp is equal to a partial voltage of Vs at a ratio of the parallel resistance of R2 and R3 to R1. Herein, since the resistance value of the piezoelectric layer 262 is usually several hundreds mega ohms or more, it hardly contributes to the parallel resistance value of R2 and R3, and is ignored in calculating the partial voltage value. If the electrode of the piezoelectric sensor 263 is disconnected, the point Pa or Pb is equivalently opened, so that Vp becomes a partial voltage value of R2 to R3. If the electrode is short-circuited, the points Pa and Pb are equivalently short-circuited, so that Vp is equal to Vs. In this manner, the abnormality determination part 257 detects a failure such as a disconnection or short-circuit of the electrode for the piezoelectric sensor 263, based on the value of Vp, whereby the reliability is improved. Also, when the disconnection of wire occurs as described above, in the case of one cable, all the cable laid down must be removed and replaced, but in this embodiment, the cable is disposed for each single fence, whereby the cable only for the disconnected piezoelectric sensor terminal unit 270 may be replaced by the simpler replacement operation.

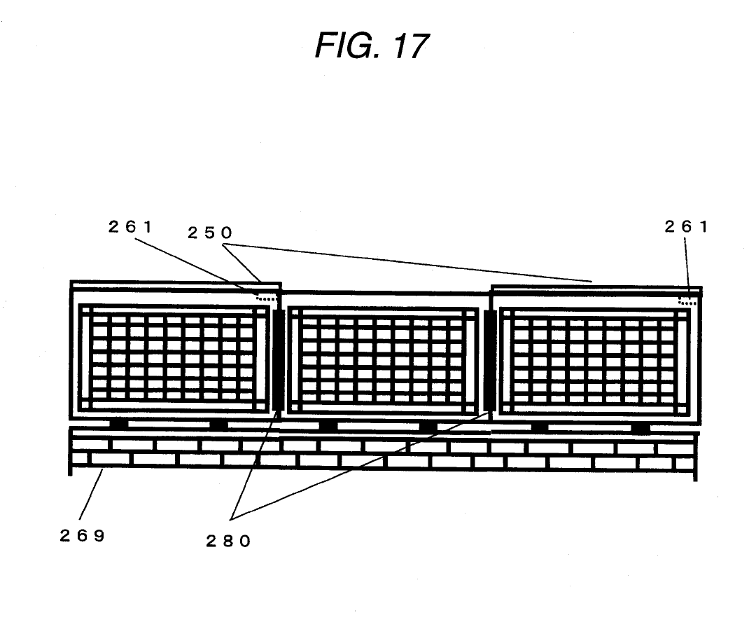

As shown in FIG. 17, the vibration propagation members 280 are employed without disposing the piezoelectric sensor terminal unit 270 on every fence to achieve the same effect as where the piezoelectric sensor terminal unit 270 is disposed on every fence. In this case, a metal member having excellent vibration transmissibility is disposed between the single fence 266 and its adjacent fence, whereby even when the intruder intrudes on the fence where the piezoelectric sensor terminal unit 270 is not disposed, the vibration of the fence 266 when the intruder intrudes is propagated to the adjacent fence where the piezoelectric sensor terminal unit 270 is disposed, so that the intrusion can be detected. Though the vibration propagation members 280 are employed in FIG. 17, the vibration is more likely to be propagated to another fence by employing the vibration propagation members 280 because there is possibly a minute gap between the fences by arranging the single fences 266. Also, the metal member having excellent transmissibility of vibration is employed for a case covering the determination means 270, whereby the case may be disposed as a vibration propagation member between the fences. Though the piezoelectric sensor terminal unit 270 is disposed on every other fence in FIG. 17, the invention is not limited thereto, but the piezoelectric sensor terminal unit 270 may be disposed on every two or more fences, as far as the vibration is fully propagated.

As described above, in the embodiment 5, when the intruder intrudes from the fence installed around the house, it is possible to specify the intrusion place, and threaten the intruder on the spot. Also, the structure that the intrusion detection part of the piezoelectric sensor terminal unit is disposed inside the fence may be adopted, whereby it is possible to dispense with the trouble of disposing the piezoelectric sensor terminal unit because the piezoelectric sensor terminal is disposed inside the fence. Also, the piezoelectric sensor terminal unit may comprise a data communication part capable of making the wireless communication with the central processing unit, whereby the central processing unit may control the start or release of the monitoring operation of the piezoelectric sensor terminal unit. Also, since the central processing unit can receive the output signals due to detection from a plurality of piezoelectric sensor terminal units, the false detection can be prevented. A method for preventing the false detection may be implemented in accordance with an embodiment 6 as described below.

### EMBODIMENT 6

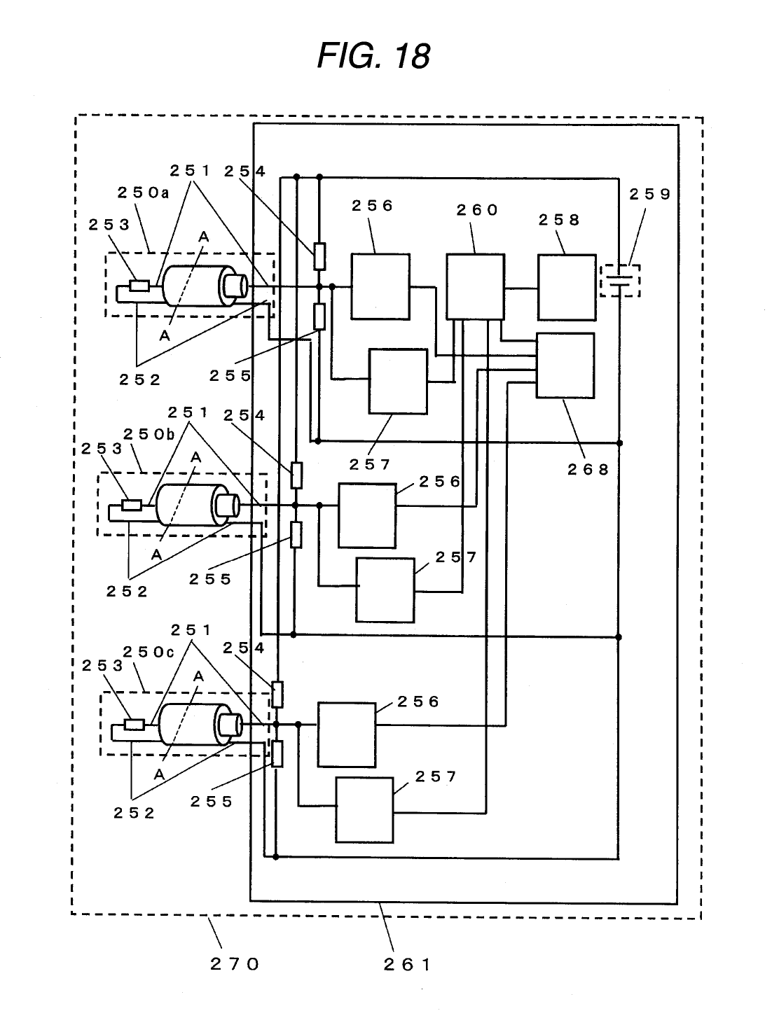

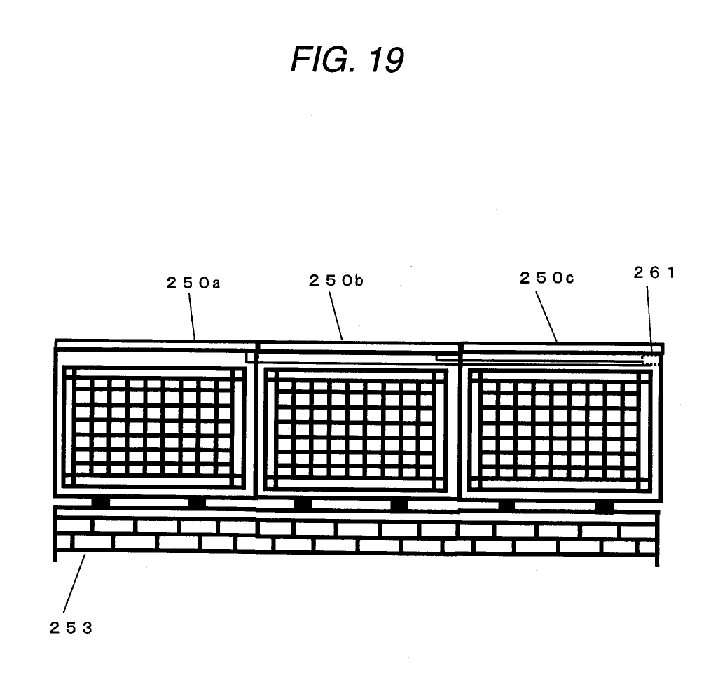

FIG. 18 is an internal block diagram of a piezoelectric sensor terminal unit of a monitoring device according to a sixth embodiment of the invention. A different point from the piezoelectric sensor terminal unit of the embodiment 5 is that intrusion determination means 268 is provided to determine whether the detection is due to the intrusion or natural phenomenon such as wind or rain based on the output signals from a plurality of intrusion detection parts 250a, 250b and 250c, as shown in FIG. 18. FIG. 19 shows a fence structure in which the piezoelectric sensor terminal unit is disposed on the fence. A different point from the disposition of the embodiment 5 is that the plurality of intrusion detection parts 250a, 250b and 250c and one determination means 261 are provided.

The operation and action of the monitoring device with the above configuration and the fence structure will be described below.

First of all, in the case where the house is surrounded on all sides by the fence, when the heavy rain or strong wind arises, for example, in the case where the intrusion detection parts 250a, 250b and 250c are disposed on the fence in the north, when the strong wind blows from the north, the detection signals are outputted from the plurality of intrusion detection parts 250a, 250b, 250c, . . . disposed on the fence in the north. Therefore, the intrusion determination means 268 judges that the detection is due to the strong wind because the output signals occur from the plurality of intrusion detection parts 250a, 250b and 250c. In the case of intrusion, when the intruder attempts to intrude into the house by getting over the fence and puts hand or foot on the upper part of the fence, the detection signals are outputted from one intrusion detection part 250a or a small number of intrusion detection parts disposed in its neighborhood, whereby the intrusion determination means 268 judges that the intrusion occurs. Also, in the case of rain or earthquake, the detection signals are outputted from the plurality of intrusion detection parts disposed on all sides, whereby the intrusion determination means 268 judges that the detection is due to heavy rain.

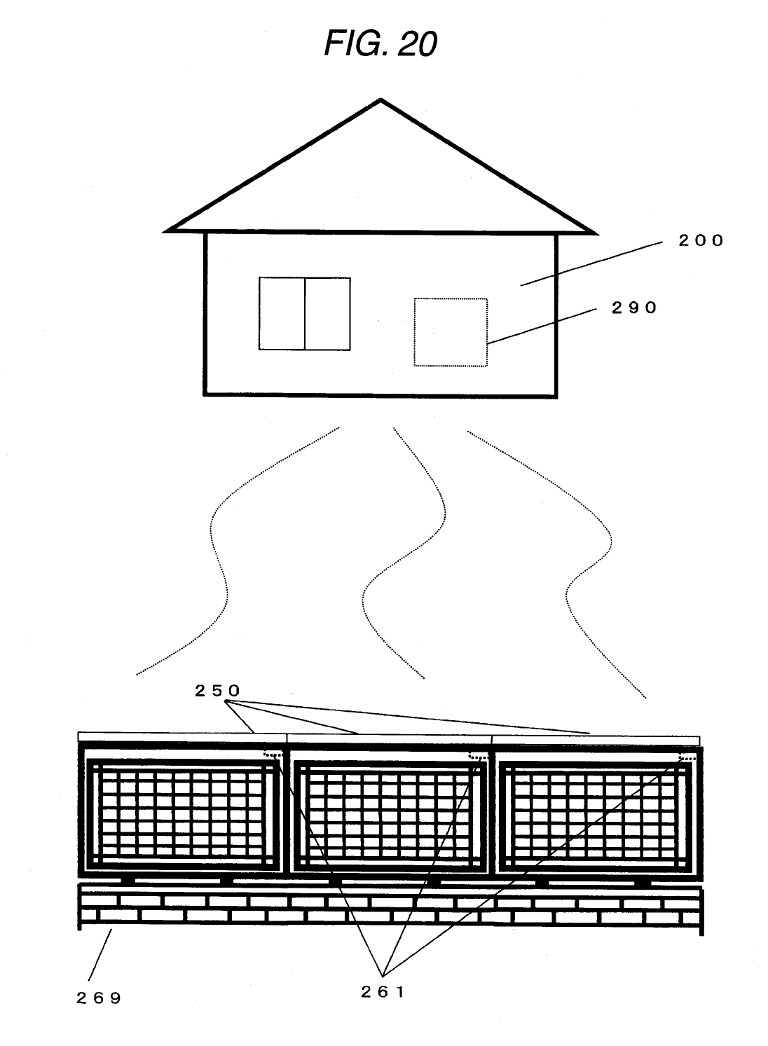

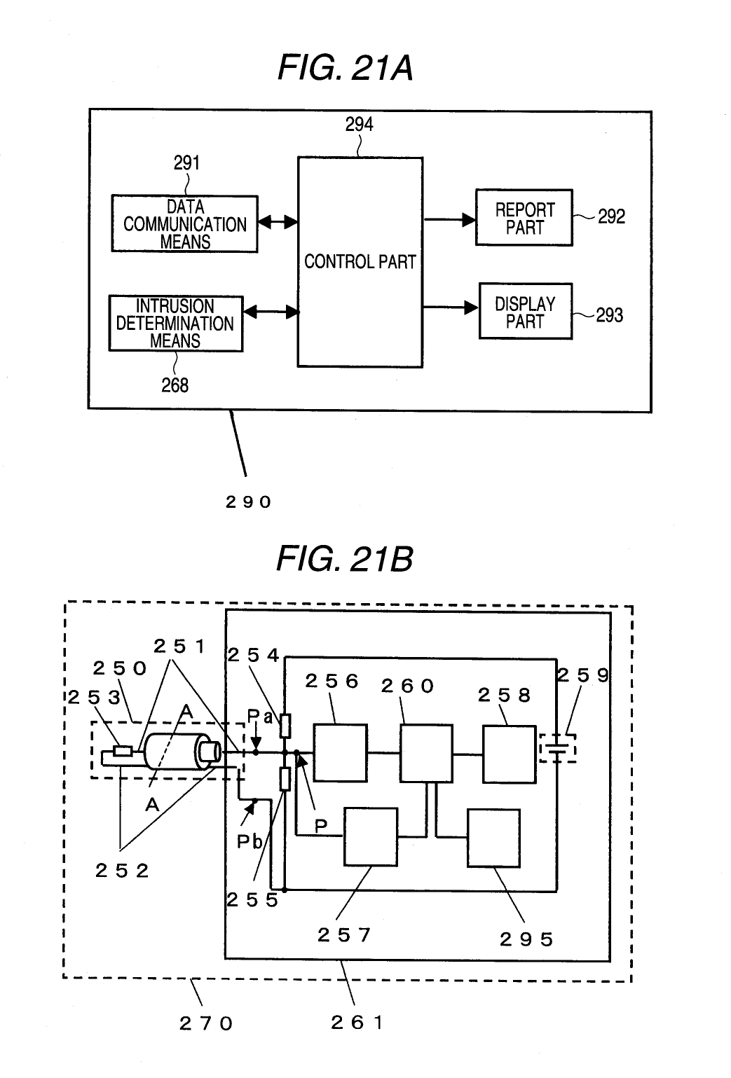

While in this embodiment the intrusion determination means 268 is provided in the determination means 261, in the case where the monitoring device is installed as in the embodiment 5, a control part for making the determination of such intrusion determination means 268 may be provided in a device for generally judging the output signal from each piezoelectric sensor terminal unit, whereby the same effect as in this embodiment is achieved. For example, if a central processing unit 290 for enabling the wireless communication with each piezoelectric sensor terminal unit is installed in the premises 200 as shown in FIG. 20, the central processing unit 290 may receive the output signal from each piezoelectric sensor terminal unit, and judge whether the detection is due to the intrusion or rain or wind. Also, the intrusion place can be specified by transmitting the ID information from each piezoelectric sensor terminal unit, along with the output signal. FIG. 21A is an internal block diagram of the central processing unit 290. Reference numeral 291 denotes data communication means, which transmits or receives the output signal from each piezoelectric sensor terminal unit. Reference numeral 268 denotes intrusion determination means. Reference numeral 292 denotes a report part for raising the alarm when the intrusion occurs. Reference numeral 293 denotes a display part for displaying from which terminal unit the output signal is received. Reference numeral 294 denotes a control part. FIG. 21B is an internal block diagram of the piezoelectric sensor terminal unit. A different point from the piezoelectric sensor terminal unit of the embodiment 5 is that data communication means 295 is provided as shown in FIG. 21.

Also, while in this embodiment the communication medium is wireless, any communication media such as wire telecommunications with dedicated line, lamp line carrier communications, infrared communications, or fiber optics communications may be employed to achieve the same effect.

Also, while in this embodiment the piezoelectric sensor terminal unit is installed on every single fence member, the invention is not limited thereto, but the piezoelectric sensor terminal unit may be disposed on every piezoelectric sensor having a predetermined length.

As the filter characteristic, the frequency of vibration at the contact of the person's hand due to the intrusion is 10 Hz or less, particularly in a range from 3 to 8 Hz. Typically, the frequency of vibration due to the rainfall is 10 Hz or more, and the frequency of vibration due to the wind is 1 Hz or less. As the filter characteristic, the filter part 256 is composed of a band pass filter for passing the signal components of 3 to 8 Hz, whereby the reliability is improved.

As described above, in the embodiment 6, the detection due to the natural phenomenon such as wind or rain and the detection due to the intrusion can be distinguished, thereby preventing the false detection. Therefore, the user has a greater sense of security.

Also, the monitoring device of the invention is not limited to the above embodiment, but various changes may be made without departing from the spirit or scope of the invention.

### EMBODIMENT 7

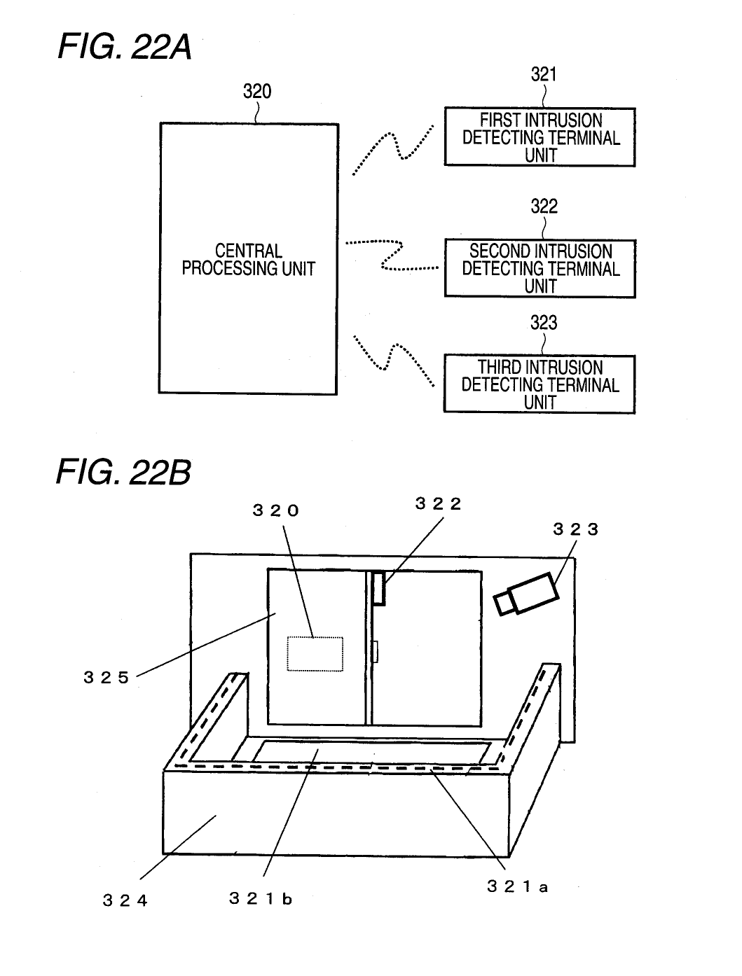

In FIG. 22A, a monitoring system comprises a central processing unit 320, a first intrusion detecting terminal unit 321, a second intrusion detecting terminal unit 322, and a third intrusion detecting terminal unit 323. Communication means makes the wireless communication between the central processing unit 320 and the first intrusion detecting terminal unit 321, the second intrusion detecting terminal unit 322 or the third intrusion detecting terminal unit 323. The first intrusion detecting terminal unit 321, the second intrusion detecting terminal unit 322 and the third intrusion detecting terminal unit 323 are disposed on the intrusion path monitoring the steady or unsteady state. Each intrusion detecting terminal unit monitors the steady or unsteady state. In this embodiment, the first intrusion detecting terminal unit 321 is provided on the intrusion path monitoring the steady or unsteady state and detects the intrusion into the intrusion path earlier. The intrusion path in this embodiment means the path trespassing on the dwelling from the veranda through the window, in which the first intrusion detecting terminal unit 321 is installed on the handrail of the veranda.

FIG. 22B shows a constitution of installation in this embodiment. The first intrusion detecting terminal unit 321a is the veranda sensor terminal unit disposed on the handrail of the veranda. Also, the first intrusion detecting terminal unit 321b is installed on the floor of the veranda to detect the step of the intruder entering the veranda. In this embodiment, the first intrusion detecting terminal unit 321 is supposed as the veranda sensor terminal unit 321a. Also, the second intrusion detecting terminal unit 322 is provided at an opening portion of the window in the veranda to make the detection later on the intrusion path than the first intrusion detecting terminal unit 321. That is, on the intrusion path, the first intrusion detecting terminal unit 321 is located on the outer side in the monitoring area to make the earlier detection than the second intrusion detecting terminal unit 322, when the intruder intrudes from the outside, and the second intrusion detecting terminal unit 322 is provided more inwards to make the earlier detection of coming and going than the first intrusion detecting terminal unit 321, when the user comes or goes through the opening portion within the dwelling. In this embodiment, the second intrusion detecting terminal unit 322 is an opening/closing sensor terminal unit installed in the opening portion of the window or door into or out of the veranda. Also, the third intrusion detecting terminal unit 323 is a surveillance camera for photographing the intrusion path where the first and second intrusion detecting terminal units are provided. And the central processing unit 320 is installed within the premises.

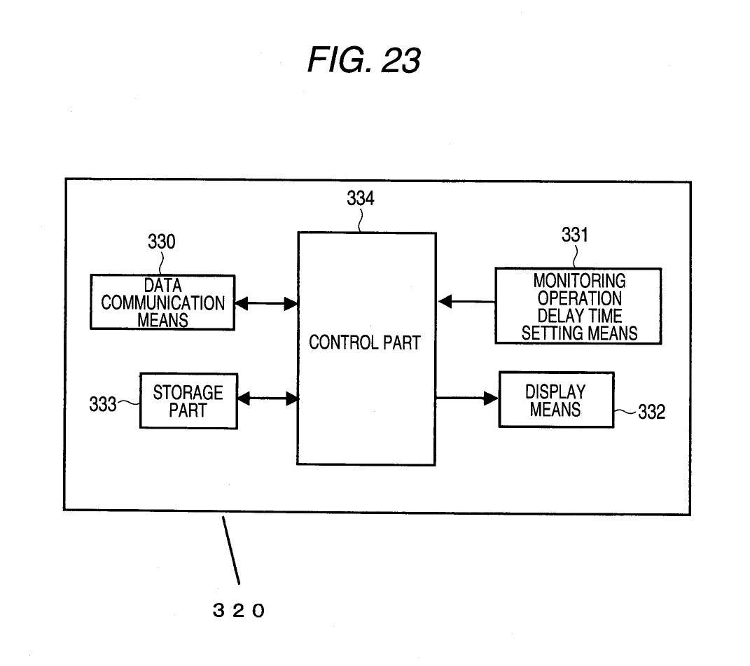

FIG. 23 is an internal block diagram of the central processing unit 320. Reference numeral 330 denotes data communication means for transmitting or receiving a signal concerning the steady state or unsteady state and a signal concerning the start and release of the monitoring operation. Reference numeral 331 denotes monitoring operation delay time setting means that sets up a delay time from receiving a closing signal from the opening/closing sensor terminal unit 322 to sending a start signal of the monitoring operation to the veranda sensor terminal unit 321. Reference numeral 332 denotes display means for displaying the monitoring operation delay time or displaying the image information of the surveillance camera 323. Reference numeral 333 denotes recording means for recording the image information of the surveillance camera 323. Reference numeral 334 denotes a control part for controlling the data communication means 330, display means 332 and storage means 333.

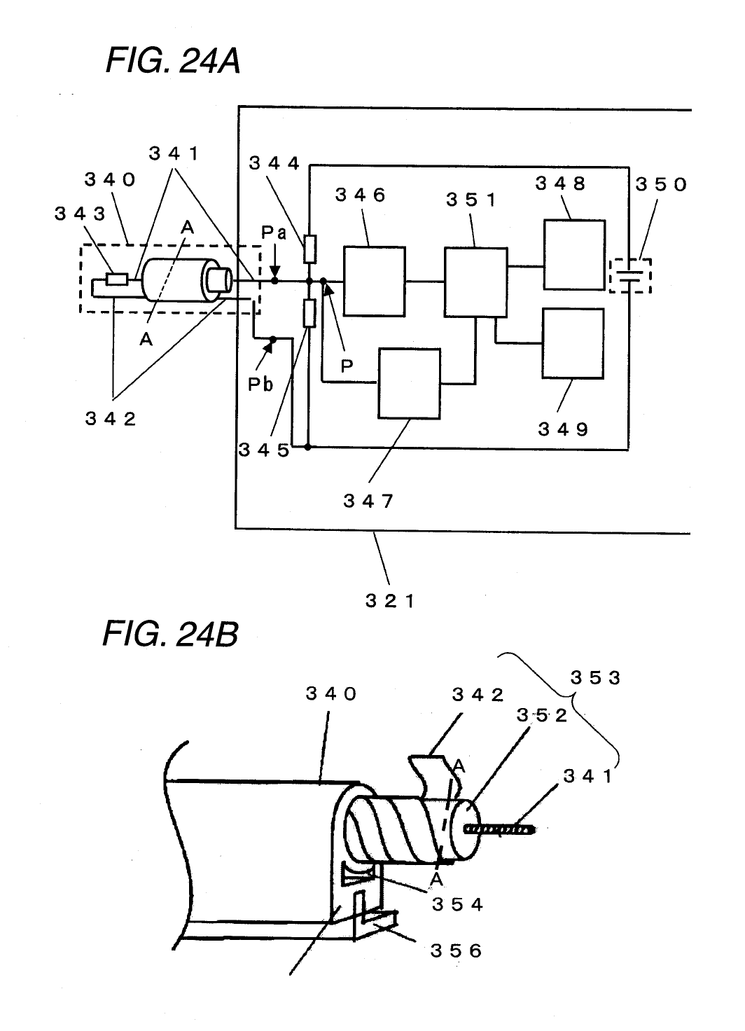

FIG. 24A is an internal block diagram of the first intrusion detecting terminal unit (veranda sensor terminal unit) 321. In this embodiment, an instance where the intrusion detecting terminal unit is disposed on the handrail of the veranda will be described below. Reference numeral 340 denotes an intrusion detection part, in which a piezoelectric sensor 353 with compliance is disposed in an elastic body 355, as shown in FIG. 24B. The piezoelectric sensor 353 generates an output signal in accordance with a deformation. The elastic body 355 is made of an elastic material such as rubber having more excellent flexibility and compliance than the piezoelectric sensor 353, so that the piezoelectric sensor 353 may be more likely to deform due to a pressure where the intruder tries to enter the dwelling from the veranda and puts hand or foot on the handrail of the veranda. Also, it is chosen in view of the heat resistance and cold resistance in installing the sensor outdoors. Specifically, the material that is scarcely degraded in compliance from −30° to 85° C. is preferably chosen. Such rubbers may include ethylene propylene rubber (EPDM), chloroprene rubber (CR), butyl rubber (IIR), silicone rubber (Si), and thermoplastic elastomer. Also, the elastic body 355 is formed hollow, and has a buffer part 354 that is compressible by pressure. Further, a groove portion to fix and support the elastic body on the veranda 356 is formed on the bottom of the elastic body 355. A fixing method on the handrail portion of the veranda may involve fitting it into the handrail portion of the veranda, or employing an adhesive tape, or any other methods may be taken as far as it can be firmly fixed on the veranda. Reference numeral 341 denotes a center electrode. Reference numeral 342 denotes a ground electrode. Reference numeral 343 denotes a sensor side resistor provided as a resistor for detecting a wire disconnection between the center electrode 341 and the ground electrode 342 at an end portion of the piezoelectric sensor 353. Reference numeral 344 denotes a circuit side resistor for detecting a wire disconnection. Reference numeral 345 denotes a signal deriving resistor for deriving a signal from the piezoelectric sensor 353. Reference numeral 346 denotes a filter part for passing only a predetermined frequency component from the output signal of the piezoelectric sensor 353. Reference numeral 347 denotes an abnormality determination part for determining a disconnection failure from the piezoelectric sensor 353. Reference numeral 348 denotes data communication means for transmitting or receiving a signal concerning the steady or unsteady state and a signal concerning the start or release of the monitoring operation to or from the central processing unit 320. Reference numeral 349 denotes report means for raising an alarm when the intrusion occurs or making a report with sound or light to inform the user of the current state when the monitoring operation is started or released. Reference numeral 350 denotes a battery. Reference numeral 351 denotes a terminal control part that sends the information that the intrusion occurs, along with the terminal unit code of its own, to the central processing unit 320 by wireless using the data communication means 348, in which the steady state is the state where the intruder is not detected during the monitoring after the start of the monitoring operation, and the unsteady state is the state where when the intruder tries to intrude into the dwelling by getting over the handrail of the veranda, the intrusion detection means 340 detects a pressure to output a signal. Also, when the data communication means 348 receives a start signal of the monitoring operation or a release signal of the monitoring operation from the central processing unit 320, the terminal control part 333 places the terminal unit in the monitoring operation start state or the monitoring operation release state. Also, when a disconnection failure is detected by the abnormality determination part 347, the report means 349 gives a report. Reference numeral 352 denotes a piezoelectric layer.

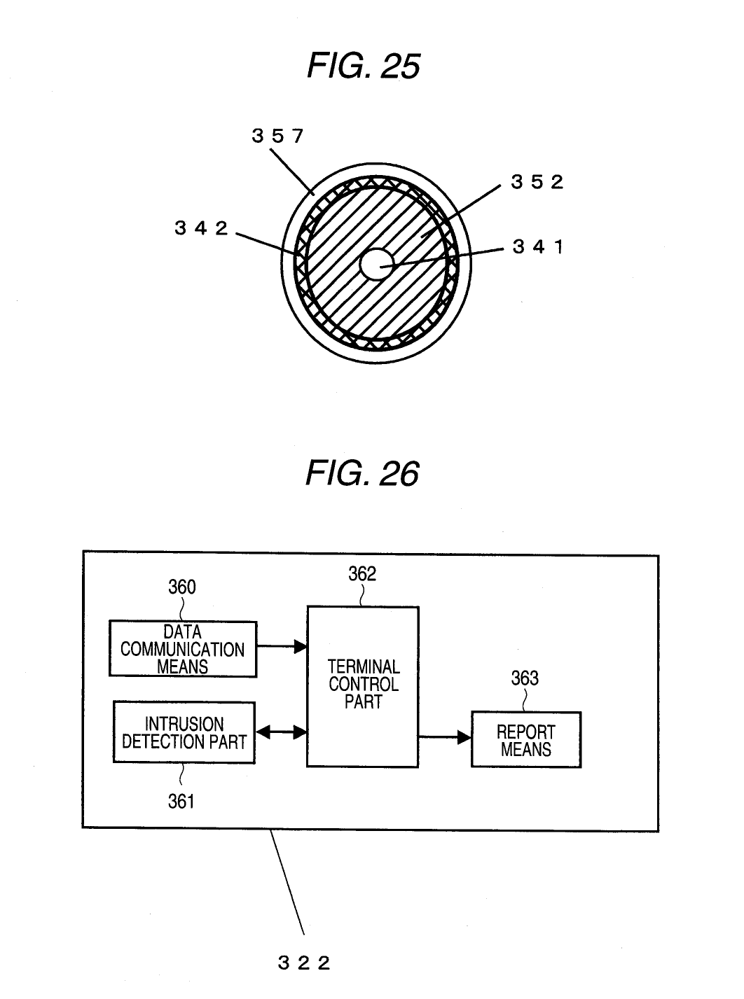

FIG. 25 is a cross-sectional view of the piezoelectric sensor 353, taken along the line A-A in FIG. 24. In FIG. 25, reference numeral 341 denotes the center electrode. Reference numeral 352 denotes the piezoelectric layer. Reference numeral 343 denotes the ground electrode. Reference numeral 357 denotes a covering layer.

The center electrode 341 may be a normal metallic solid conductor, but is the electrode having a metallic coil wound around an insulating polymeric fiber here. The insulating polymeric fiber and the metallic coil are preferably polyester fiber commercially available in the electric heating blanket and copper alloy containing 5 wt % of silver, respectively.

The piezoelectric layer 352 is typically made of a resin-based piezoelectric polymer such as polyvinylidene fluoride, and the high temperature durability is increased by using a piezoelectric compound in which a powder of piezoelectric ceramics is mixed into polymeric base material such as chlorinated polyethylene.

The ground electrode 343 is a strip electrode in which a metallic film is bonded on a polymeric layer, and is wound around the piezoelectric layer 352. And the polymeric layer is made of polyethylene terephthalate (PET). An electrode with an aluminum film bonded on the polymeric layer is preferable as the ground electrode 343, because it has a high thermal stability at 120° C., and is mass-produced commercially. To shield the piezoelectric sensor 353 from the electrical noise of external environment, it is preferable that the ground electrode 343 is wound around the piezoelectric layer 352 so as to partially overlap.

The covering layer 357 is made of polymeric material having adequate elasticity such as urethane, polyethylene or vinyl chloride.

FIG. 26 is an internal block diagram of the second intrusion detecting terminal unit (opening/closing sensor terminal unit) 322. In this embodiment, an instance where the intrusion detecting terminal unit is installed on the window or door into or out of the veranda will be described below. Reference numeral 360 denotes data communication means for transmitting or receiving a signal concerning the steady or unsteady state and a signal concerning the start or release of the monitoring operation to or from the central processing unit 320. Reference numeral 361 denotes an intrusion detection part for detecting the opening or closing of the window or door in such a manner that a reed switch is provided, the opening/closing sensor terminal unit 323 is mounted on the frame of window or door, and a magnet acting for opening or closing is affixed corresponding to the reed switch on the window glass or door opening or closing part that is a movable part. In this embodiment, the state where the opening of window or door is detected is the unsteady state, and the state where the closing of window or door is detected is the steady state. Reference numeral 362 denotes a terminal control part that sends the opening or closing information in opening or closing the window or door, along with the terminal unit code of its own, to the central processing unit 320 by wireless using the data communication means 360. Reference numeral 332 denotes report means for giving a report to the outside when the window or door is opened.

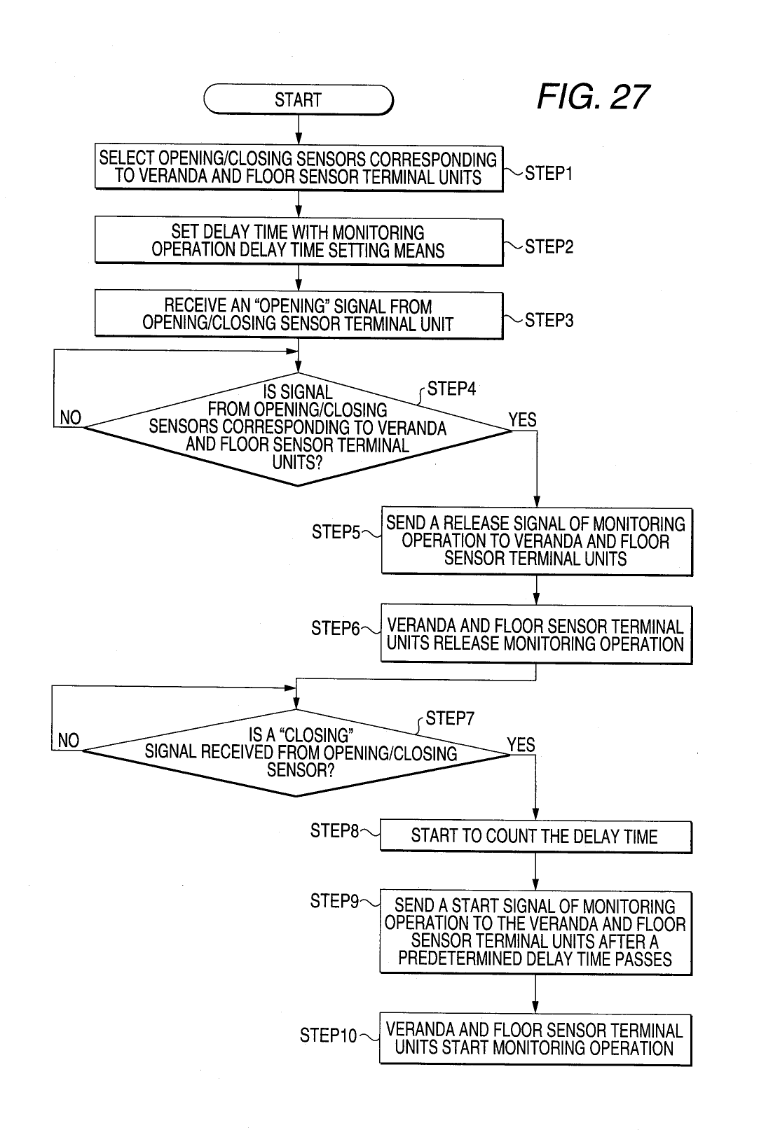

FIG. 27 is a flowchart showing the operation for releasing and starting the monitoring operation in cooperation with the first intrusion detecting terminal unit (veranda sensor terminal unit) 321 and the second intrusion detecting terminal unit (opening/closing sensor terminal unit) 322 in the monitoring operation start state of this embodiment.

The operation and action of the monitoring device with the above configuration will be described below.

At STEP 1, the central processing unit 320 selects the first intrusion detecting terminal unit (veranda sensor terminal unit) 321 disposed on the handrail of veranda and the second intrusion detecting terminal unit (opening/closing sensor terminal unit) 322 disposed on the window or door into or out of the veranda to cope with the situation. Thereby, even when a plurality of terminal units are installed, the start or release of the monitoring operation can be appropriately performed.

At STEP 2, the monitoring operation delay time setting means 331 sets up a delay time until the first intrusion detecting terminal unit (veranda sensor terminal unit) 321 starts the monitoring operation.

At STEP 3, the window or door where the second intrusion detecting terminal unit (opening/closing sensor terminal unit) 322 is disposed is opened, the intrusion detection part 361 detects the opening, and the second intrusion detecting terminal unit (opening/closing sensor terminal unit) 322 sends an opening signal to the central processing unit 320 using the data communication means 360. The central processing unit 320 receives the opening signal using the data communication means 330.

At STEP 4, the central processing unit 320 judges whether or not there is the first intrusion detecting terminal unit (veranda sensor terminal unit) corresponding to the second intrusion detecting terminal unit (opening/closing sensor terminal unit) 322. In this embodiment, since the first intrusion detecting terminal unit (veranda sensor terminal unit) 321 corresponds to the second intrusion detecting terminal unit (opening/closing sensor terminal unit) 322, the procedure goes to STEP 5. Each signal includes the terminal unit code of each terminal unit, and the central processing unit 320 collates the terminal unit code of each signal with the recorded terminal unit code of the terminal unit and judges from which terminal unit each signal is sent, every time of receiving each signal. The terminal unit similarly judges the central processing unit.

At STEP 5, the central processing unit 320 sends a release signal of the monitoring operation to the first intrusion detecting terminal unit (veranda sensor terminal unit) 321.

At STEP 6, the first intrusion detecting terminal unit (veranda sensor terminal unit) 321 receives the release signal of the monitoring operation from the central processing unit 320 using the data communication means 348, and releases the monitoring operation of the intrusion detection part 340 using the terminal control part 351. At this time, the report means 349 issues a voice message concerning the release of the monitoring operation, or turns on the LED to notify the outside or monitoring user that the monitoring operation is released.

At STEP 7, the central processing unit 320 judges whether or not a closing signal is received from the second intrusion detecting terminal unit (opening/closing sensor terminal unit) 322, and if so, the operation goes to STEP 8.

At STEP 8, counting of the delay time set up at STEP 2 is started. If the user works in the veranda in a state where the window or door into or out of the veranda is opened, the monitoring operation may be started without delay time. However, when the user works in a state where the window or door is closed, a certain delay time is provided, because if there is no delay time before starting the monitoring operation, the user himself or herself may be detected.

At STEP 9, the central processing unit 320 sends a start signal of the monitoring operation to the first intrusion detecting terminal unit (veranda sensor terminal unit) 321 after the passage of the set delay time.

At STEP 10, the first intrusion detecting terminal unit (veranda sensor terminal unit) 321 having received the start signal of the monitoring operation starts the monitoring operation. At this time, the report means 349 issues a voice message concerning the start of the monitoring operation, or turns on the LED to notify the outside or monitoring user that the monitoring operation is started.

While in this embodiment the first intrusion detecting terminal unit is installed on the handrail of the veranda, an intrusion detecting terminal unit capable of detecting the step may be installed on the floor of the veranda and employed as the first intrusion detecting terminal unit to achieve the same effect.

If the opening is detected by the intrusion detection part of the second intrusion detecting terminal unit (opening/closing sensor terminal unit) with one terminal control part for the first intrusion detecting terminal unit (veranda sensor terminal unit) and the second intrusion detecting terminal unit (opening/closing sensor terminal unit), not via the central processing unit, the monitoring operation of the first intrusion detecting terminal unit (veranda sensor terminal unit) may be released, or the wireless communication may be made between the first intrusion detecting terminal unit (veranda sensor terminal unit) and the second intrusion detecting terminal unit (opening/closing sensor), whereby the intrusion detecting terminal unit by itself can perform the operation, not via the central processing unit.

While in this embodiment the intrusion path is the path trespassing on the dwelling through the window from the veranda, the monitoring area may be within the dwelling inside the fence or barrier including the premises such as a garden, and the intrusion path may be the path trespassing through the window or door over the fence or barrier, whereby the first intrusion detecting terminal unit may be installed on the fence, barrier or gate door to detect the intruder to get over the fence or barrier, or the opening/closing of the gate door, and the second intrusion detecting terminal unit may be installed at the door of the porch to detect the opening/closing of the door to achieve the same effect as the embodiment 1. Also, the first intrusion detecting terminal unit may be disposed on the handrail of the veranda, and the second intrusion detecting terminal unit may be installed on the floor of the veranda as the intrusion detecting terminal unit for detecting the step to achieve the same effect. A combination of a plurality of detection terminal units may be provided on the intrusion path to monitor so that the order of detection upon intrusion may be specified on the same intrusion path, or the order of detection when the user enters or exits through the opening portion may be specified.

Next, a procedure for disconnection determination in the abnormality determination part 347 will be described below. In FIG. 24A, it is assumed that the resistance values of the sensor side resistor 343, the circuit side resistor 344 and the signal deriving resistor 345 are R1, R2 and R3, the voltage at point P is Vp and the voltage of the battery 350 is Vs. R1, R2 and R3 usually have resistance values of several mega to several tens mega ohms. When the electrode of the piezoelectric sensor 353 is normal, Vp is equal to a partial voltage of Vs at a ratio of the parallel resistance of R2 and R3 to R1. Herein, since the resistance value of the piezoelectric layer 352 is usually several hundreds mega ohms or more, it hardly contributes to the parallel resistance value of R2 and R3, and is ignored in calculating the partial voltage value. If the electrode of the piezoelectric sensor 353 is disconnected, the point Pa or Pb is equivalently opened, so that Vp becomes a partial voltage value of R2 to R3. If the electrode is short-circuited, the points Pa and Pb are equivalently short-circuited, so that Vp is equal to Vs. In this manner, the abnormality determination part 347 detects a failure such as a disconnection or short-circuit of the electrode for the piezoelectric sensor 353, based on the value of Vp, whereby the reliability is improved.

The operation of the third intrusion detecting terminal unit (surveillance camera) 323 will be described below.

In this embodiment, the third intrusion detecting terminal unit (surveillance camera) 323 having the data communication means is installed in the veranda, and associated with the first intrusion detecting terminal unit (veranda sensor terminal unit) 321 installed on the handrail of the veranda by the central processing unit 320. Though in this embodiment, the third intrusion detecting terminal unit (surveillance camera) 323 is associated with one intrusion detecting terminal unit, the third intrusion detecting terminal unit (surveillance camera) 323 may be associated with a plurality of intrusion detecting terminal units. An instance where the intruder from the veranda is detected will be described below.

First of all, if the first intrusion detecting terminal unit (veranda sensor terminal unit) 321 disposed on the handrail of the veranda detects the intruder trying to enter the housing from the veranda, it sends an unsteady signal, namely, information that the intrusion occurs, to the central processing unit 320. If the central processing unit 320 receives the unsteady signal, it sends a start signal of the monitoring operation to the third intrusion detecting terminal unit (surveillance camera) 323. If the third intrusion detecting terminal unit (surveillance camera) 323 receives the start signal of the monitoring operation, it starts to photograph the monitoring area. At this time, the image information of the surveillance camera can be confirmed on the display means 332 of the central processing apparatus 320. Also, since the image information can be recorded by the recording means 333, the user can confirm the image later. Further, after a predetermined time passes, the central processing unit sends a release signal of the monitoring operation to stop photographing with the surveillance camera, whereby the unnecessary photograph can be eliminated.

The image information may be stored in the recording means of the third intrusion detection termination unit (surveillance camera) 323, or recorded on the recording media.

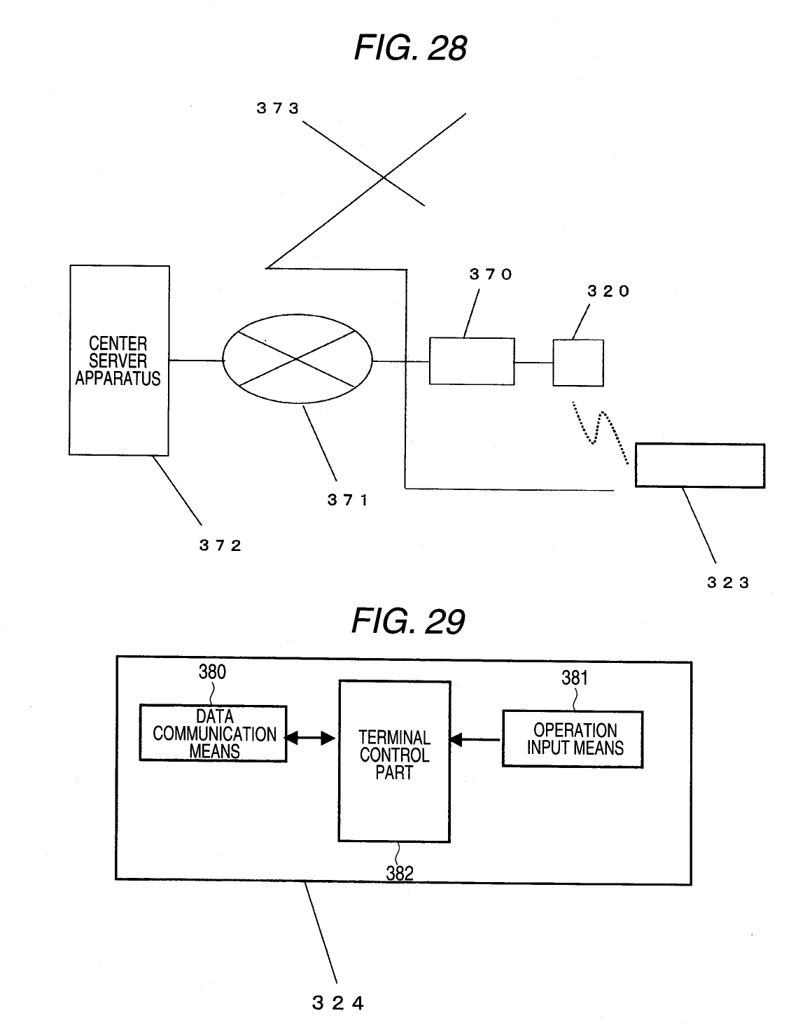

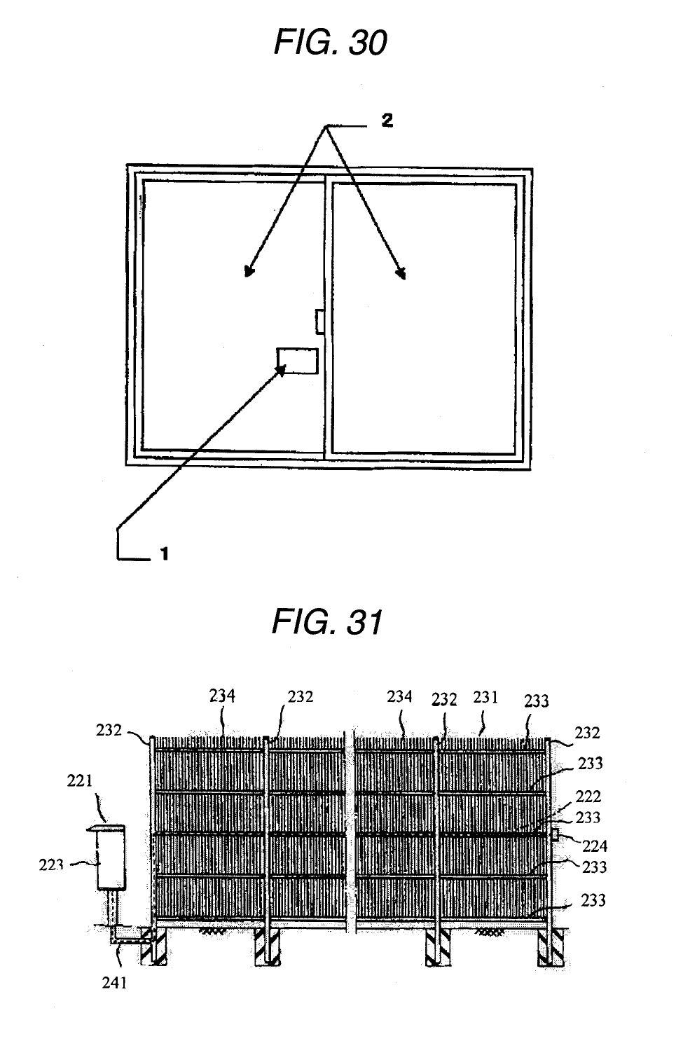

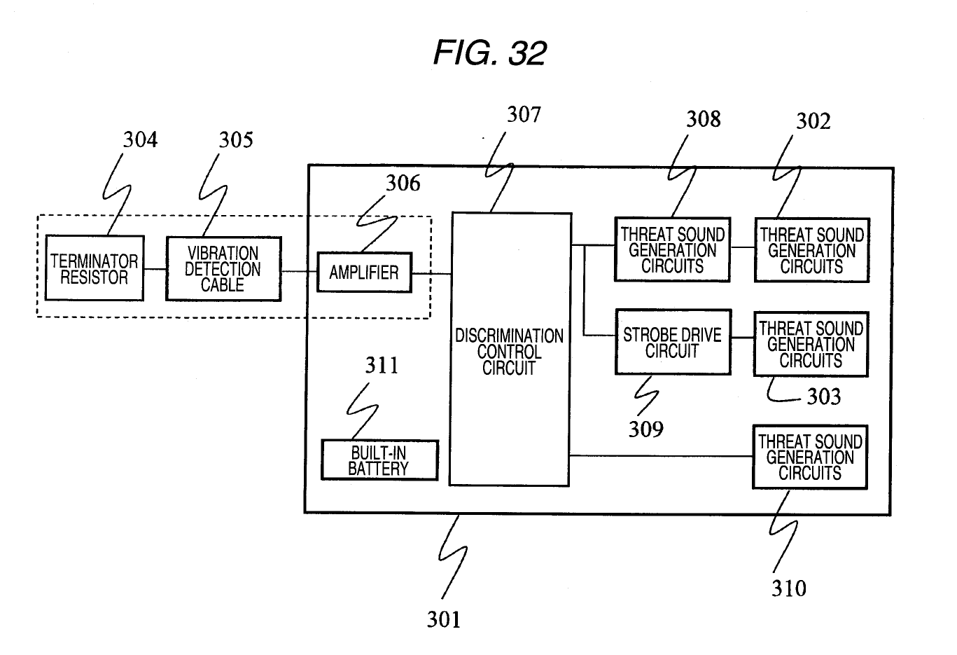

With the configuration as shown in FIG. 28, the image information of the third intrusion detection termination unit (surveillance camera) 323 can be confirmed from a portable telephone or a PC off the premises. First of all, when the intrusion occurs from the veranda, the third intrusion detection termination unit (surveillance camera) 323 picks up the image information. And the central processing unit 320 makes contact with a center server apparatus 372 to inform that the intrusion happens on the portable telephone. It is possible to connect the portable telephone having received a failure due to the intrusion to the central processing unit 320, and confirm the image information of the third intrusion detection termination unit (surveillance camera) 323 on the portable telephone.

While in this embodiment the public line is employed, the invention is limited thereto, but may be involved in a communication apparatus such as a personal computer or a portable information terminal, as well as the dedicated line or the Internet line.

While in this embodiment, the third intrusion detection termination unit is the surveillance camera for photographing the intrusion path, a threatening light may be installed instead of or in addition to the surveillance camera. In this case, the threatening light having the data communication means is installed on the veranda, and associated with the first or second intrusion detecting terminal unit installed on the handrail of the veranda by the central processing unit. And if the first or second intrusion detecting terminal unit detects the intrusion, an unsteady signal, namely, information that the intrusion happens, is sent to the central processing unit. If receiving the unsteady signal, the central processing unit sends a start signal (signal turning ON the light) of the monitoring operation to the threatening light. If receiving the start signal of the monitoring operation, the threatening light turns on to illuminate or photograph a range where the intrusion detecting terminal unit detecting the intrusion is provided. At this time, the threatening light may be turned off after a predetermined time passes, or the light may be turned off by sending a release signal (signal turning OFF the light) of the monitoring operation from the central processing unit, thereby avoiding unnecessary lighting.

As described above, in the embodiment 7, the first intrusion detecting terminal unit (veranda sensor terminal unit) is disposed on the handrail of the veranda, and the second intrusion detecting terminal unit (opening/closing sensor) is installed on the window or door into or out of the veranda, whereby if the user opens the window or door to work in the veranda, the second intrusion detecting terminal unit (opening/closing sensor) sends an unsteady (opening) signal, and the central processing unit receiving the unsteady (opening) signal sends a release signal of the monitoring operation to the first intrusion detecting terminal unit (veranda sensor terminal unit), so that the user can release the monitoring operation without performing any operation on the first intrusion detecting terminal unit (veranda sensor terminal unit).

In recent years, with the increasing number of theft criminals, there is an increasing demand for the monitoring device in the domiciles, and particularly, since the veranda has a sound stage and is hardly seen from the outside, there is an increasing demand for the monitoring device that can be mounted on the handrail of the veranda. However, since the bedding or washing is often hung out in the veranda, if the monitoring device is mounted in the veranda, the user needs to turn off the power of the monitoring device or release the warning operation every time of getting out to the veranda. However, with the constitution of the embodiment 7, the user can get into or out of the veranda without performing any specific operation, whereby the ease-of-use is improved. Also, since the user can recognize the monitoring state of the intrusion detecting terminal unit visually or aurally, the user is not falsely detected and threatened by the alarm.

In the case where the surveillance camera or the threatening light is disposed in the veranda, if the intrusion is detected by the first intrusion detecting terminal unit or the second intrusion detecting terminal unit, the image information can be confirmed or stored by the surveillance camera, or the intruder can be threatened by the light.

Also, while in the embodiment 7 the communication medium is wireless, any communication media such as wire telecommunications with dedicated line, lamp line carrier communications, infrared communications, or fiber optics communications may be employed to achieve the same effect.

### EMBODIMENT 8

FIG. 29 is a system block diagram of a remote controller according to an eighth embodiment of the invention. The terminal unit 324 is the remote controller that the user can carry. Reference numeral 380 denotes data communication means that can make the wireless communication with the intrusion detecting terminal unit. The data communication means transmits a signal concerning the release of the monitoring operation. The intrusion detecting terminal unit means the veranda sensor terminal unit installed on the handrail of the veranda or the opening/closing sensor terminal unit for detecting the opening/closing of the window or door as described in the embodiment 7. Reference numeral 381 denotes operation input means for issuing or stopping a signal concerning the release of the monitoring operation by a manipulation of the user. Reference numeral 382 denotes a terminal unit control part for issuing or stopping a signal from the data communication means 380 by an operation input from the operation input means 381.

The operation and action of the monitoring device with the above configuration will be described below.

First of all, if the intrusion detecting terminal unit installed in the veranda is in a monitoring state when the user resides in the house, the user carelessly opens the window or gets out to the veranda, and is detected by the intrusion detecting terminal unit and threatened by the alarm in some cases, unless the monitoring state of each intrusion detecting terminal unit is released. Thus, in the embodiment 8, the user performs an operation of pressing a switch on the operation input means 381 of the remote controller 324 to issue a release signal of the monitoring operation so that the user may not be falsely threatened by the alarm. At this time, the release signal of the monitoring operation is sent periodically, for example, at every other second. And when the user comes near the intrusion detecting terminal unit carrying the remote controller 324, the intrusion detecting terminal unit receives a release signal of the monitoring operation from the remote controller 324 to release the vigilance. Therefore, even when the user works in the veranda where the intrusion detecting terminal unit is installed, the user is not threatened by the alarm. Also, the terminal unit code of the terminal unit for the remote controller 324 is stored beforehand in the intrusion detecting terminal unit, whereby it is possible to judge whether or not the received release signal of the monitoring operation is from the remote controller 324. And if the user ends working in the veranda and leaves from the veranda, and the intrusion detecting terminal unit can not receive the release signal of the monitoring operation form the remote controller 324, the intrusion detecting terminal unit starts the monitoring operation. Therefore, the user does not need to perform an operation of releasing or starting the monitoring operation of the intrusion detecting terminal unit, whereby the ease-of-use is improved especially in the case where a plurality of terminal units such as the veranda sensor terminal units or opening/closing terminal units are engaged in the monitoring operation. Also, since the remote controller 324 can stop the release signal of the monitoring operation if a predetermined time passes since the release signal of the monitoring operation is sent by performing a manipulation on the operation input means 381, it is possible to prevent the user from forgetting to turn off the power.

As described above, in the embodiment 8, when the user moves to the veranda, carrying the remote controller, the intrusion detecting terminal unit installed in the veranda releases the monitoring operation, whereas when the user leaves from the veranda, the intrusion detecting terminal unit starts the monitoring operation, whereby it is not required to perform an operation of turning on or off the power of the terminal unit, which was required with the conventional monitoring device. Also, in the case where the central processing unit releases the monitoring operation of the sensor terminal units, the central processing unit releases all the sensor terminal units. Therefore, when the user works in the veranda, the monitoring operation of the other sensor terminal units is also released, whereby it is considered that the intrusion may occur for the interim. However, in the invention, since the monitoring operation of only the intrusion detecting terminal units near the place where the user works can be released, the user has a greater sense of security.

The means as explained in this embodiment may take the form of a program in cooperation with the hardware resources such as an electrical information apparatus, a computer or a server having a CPU (or microcomputer), RAM, ROM, a storage/recording device and an I/O unit. The program may be recorded on the recording medium such as magnetic media or optical media, or distributed using the communication line such as the Internet, whereby the distribution of new functions or renewal of functions, or the installation operation can be simplified. Also, the monitoring device of the invention is not limited to the above embodiment, but various changes may be made without departing from the spirit or scope of the invention.

While the present invention has been described above in detail in connection with the specific embodiments, it will be apparent to those skilled in the art that various changes or modifications may be made without departing from the spirit or scope of the invention.

This application is based on Japanese Patent Application No. 2004-229211 filed on Aug. 5, 2004, Japanese Patent Application No. 2004-229212 filed on Aug. 5, 2004, Japanese Patent Application No. 2005-114129 filed on Apr. 12, 2005, and Japanese Patent Application No. 2005-213669 filed on Jul. 25, 2005, the contents of which are incorporated herein by reference.

### INDUSTRIAL APPLICABILITY

As described above, the monitoring device and the program according to the invention detects the presence or absence of the person under the window or near the corridor to draw the attention. Thereafter, when the window or door is opened, the intrusion is judged, and the alarm is raised. They are applicable to the devices used for other security purposes, for example, a car security in which if a man roaming about the car or the vibration of a car body is detected, the attention is drawn, and then if it is detected that the window is broken, or the man sits on the seat, the alarm is raised.

Also, in the monitoring device according to the invention and its fence structure, the sensor terminal unit is disposed on every single fence, making it possible to specify the intrusion place of the intruder, or distinguish between the sensor detection due to the natural phenomenon such as rain or wind and the sensor detection due to the intrusion, whereby the monitoring device and its fence structure are applicable for various purposes in cooperation with the other devices. For example, when the intrusion occurs, the intruder may be threatened by a device such as a light or alarm near the intrusion place, or if the detection due to the rain is made, the roof of the veranda where the washing is hung out can be automatically extended.

As described above, with the monitoring device and its program according to the invention, if the intrusion detecting terminal unit disposed in the veranda detects that the user gets into or out of the veranda, the monitoring state of the intrusion detecting terminal unit disposed in the veranda can be started or released, whereby the monitoring device and its program are applicable to the other devices useful for the security purposes, for example, a car security in which when the key of car door is unlocked, the monitoring device mounted on the car is released.

While in the above embodiments the data communication means is provided for each intrusion detecting terminal unit and can make the communication with each other, the data communication means dedicated for reception but not for the bi-directional communication may be provided to receive the information from the first intrusion detecting terminal unit and the second intrusion detecting terminal unit, in which each intrusion detecting terminal unit may monitor the steady or unsteady state in accordance with the output of the data communication means. In this case, the data communication means is provided separately from each intrusion detecting terminal unit, or integrally with any intrusion detecting terminal unit. Since the unidirectional communication means may generally have a simpler constitution than the bi-directional communication means, the constitution of the device itself is simple and compact and easily installed.

1: A monitoring device comprising:
first and second intrusion detecting terminal units for monitoring and detecting a steady or unsteady state, which are provided on an intrusion path, said first intrusion detecting terminal unit being disposed to make a detection prior to said second intrusion detecting terminal unit at the time of intrusion, and
data communication means for receiving the information of said first intrusion detecting terminal unit and said second intrusion detecting terminal unit, in which said monitoring device monitors the state in accordance with an output of said data communication means.

2. (canceled)

3: The monitoring device according to claim 1, wherein the monitoring is started or released in accordance with the output of said data communication means.

4: The monitoring device according to claim 1, wherein when said second intrusion detecting terminal unit detects the unsteady state prior to said first intrusion detecting terminal unit, the monitoring of the first intrusion detecting terminal unit and the second intrusion detecting terminal unit is released.

5: The monitoring device according to claim 1, wherein when said second intrusion detecting terminal unit detects the steady state, said first and second intrusion detecting terminal units start the monitoring.

6: The monitoring device according to claim 1, wherein the monitoring start of said intrusion detecting terminal unit can be delayed.

7: The monitoring device according to claim 1, further comprising report means, which makes a first report when the first intrusion detecting terminal unit detects the unsteady state after staring the monitoring, and then makes a second report when the second intrusion detecting terminal unit detects the unsteady state.

8: The monitoring device according to claim 7, wherein said report means does not make the report if the second intrusion detecting terminal unit detects the unsteady state before the first intrusion detecting terminal unit detects the unsteady state.

9: The monitoring device according to claim 7, further comprising report means for each intrusion detecting terminal unit, in which said report means reports a detection situation of said intrusion detecting terminal unit.

10: The monitoring device according to claim 1, further comprising a central processing unit, in which said central processing unit has display means for displaying the detection situation of the intrusion detecting terminal unit, recording means for recording the detection situation of the intrusion detecting terminal unit, and data communication means capable of communicating with a plurality of intrusion detecting terminal units, and starts or releases the monitoring of said plurality of intrusion detecting terminal units.

11: The monitoring device according to claim 1, further comprising a remote controller having data communication means capable of communicating with the plurality of intrusion detecting terminal units, in which said remote controller releases the monitoring of the specific intrusion detecting terminal unit.

12: The monitoring device according to claim 1, wherein at least one of the first intrusion detecting terminal unit and the second intrusion detecting terminal unit is provided around the circumference of a monitoring area.

13: The monitoring device according to claim 12, wherein at least one of the first intrusion detecting terminal unit and the second intrusion detecting terminal unit is provided on a wall-like structure.

14: The monitoring device according to claim 13, wherein said wall-like structure is a handrail of the veranda.

15: The monitoring device according to claim 13, wherein said wall-like structure is a fence or a gate door.

16: The monitoring device according to claim 1, wherein the second intrusion detecting terminal unit is provided at an opening portion in the monitoring area.

17: The monitoring device according to claim 16, wherein said opening portion is an opening/closing portion of the window in the domicile.

18: The monitoring device according to claim 16, wherein said opening portion is a door in the domicile.

19: The monitoring device according to claim 1, wherein at least one of the first and second intrusion detecting terminal units is a sensor for detecting the step.

20: The monitoring device according to claim 1, wherein at least one of the first and second intrusion detecting terminal units has a piezoelectric cable sensor.

21: The monitoring device according to claim 1, further comprising a third intrusion detecting terminal unit for photographing a part or all of the monitoring area, wherein said third intrusion detecting terminal unit starts the photographing when the first or second intrusion detecting terminal unit detects the unsteady state.

22: The monitoring device according to claim 1, wherein at least one of the first and second intrusion detecting terminal units has a plurality of piezoelectric cable sensors to specify an intrusion place based on the outputs of said plurality of piezoelectric cable sensors.

23: The monitoring device according to claim 22, wherein said plurality of piezoelectric cable sensors are connected by a vibration propagation member.

24: The monitoring device according to claim 22, which determines a signal due to the natural phenomenon based on the signal outputs of the plurality of piezoelectric cable sensors.

25: A program for enabling a computer to perform at least part of the functions of the monitoring device according to claim 1.

26: A monitoring device according to claim 1, wherein said data communicating means includes first data communicating unit provided in said first intrusion detecting terminal and second data communicating unit provided in said second intrusion detecting terminal unit.
